(19) United States
(12) Patent Application Publication
(10) Pub. No.: US 2006/0151907 A1
(43) Pub. Date: Jul. 13, 2006

(54) Method of manufacturing electrophotographic seamless belt and electrophotographic apparatus

(75) Inventors: Ryota Kashiwabara, Mishima-shi (JP); Hiroyuki Kobayashi, Fuji-shi (JP); Tsunenori Ashibe, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/315,306

(22) Filed: Dec. 23, 2005

Related U.S. Application Data
(63) Continuation of application No. PCT/JP05/16238, filed on Sep. 5, 2005.

(30) Foreign Application Priority Data
Sep. 8, 2004 (JP) 2004-261464

(51) Int. Cl. B29C 49/08; B29C 37/02

(52) U.S. Cl. 264/138; 264/532

(57) ABSTRACT

A method of manufacturing an electrophotographic seamless belt, includes setting a substantially cylindrical preform made of a thermoplastic resin mixture containing a thermoplastic resin and having an outer diameter “a”, in a seamless belt molding die including a cylindrical cavity having an inner diameter “b”, and stretch blow molding at a predetermined stretch temperature T1 to obtain a stretch-blow-molded part; and cutting the stretch-blow-molded part to obtain a seamless belt. The thermoplastic resin mixture has a temperature T2 at which a parameter S/P calculated from a tensile-stress to strain curve obtained by performing a JIS K7161 test on a sheet test piece made of the thermoplastic resin mixture is 2.0 to 15.0 T2 is set as the predetermined stretch temperature T1. P indicates stress when a stretch magnification is 0.6×(b/a) and S indicates stress when the stretch magnification is 1.6×(b/a) and (b/a)≧1.7.

### TECHNICAL FIELD

The present invention relates to a method of manufacturing a seamless belt used for an image forming apparatus using an electrophotographic process, which is called an electrophotographic apparatus, such as a copying machine or a color printer, that is, a method of manufacturing an electrophotographic seamless belt. In addition, the present invention relates to an electrophotographic apparatus including the electrophotographic seamless belt; obtained by the manufacturing method.

### BACKGROUND ART

An electrophotographic apparatus using an electrophotographic seamless belt such as an intermediate transfer belt or a transfer material transport belt is useful as a color electrophotographic apparatus for sequentially superimposingly transferring a plurality of component color images corresponding to color image information to output an image formation on which the color images are synthetically reproduced.

Now, a method of manufacturing the electrophotographic seamless belt includes a tube extrusion molding method, an inflation molding method, a centrifugal molding method, a blow molding method, and an injection molding method.

Among these methods, the blow molding method has the advantage that the outer size of a molded part is stabilized because a die is used. A stretch blow molding method which is a type of the blow molding method has the advantage that the strength of a molded part is improved because molecular orientation is caused by stretching. The stretch blow molding method has high reproducibility, so it is a molding technique capable of stably forming products which are uniform in quality. In addition, high-speed molding can be performed, so the stretch blow molding method is a molding technique capable of achieving a reduction in cost.

Several electrophotographic seamless belts formed by the stretch blow molding method have been proposed (see, for example, JP 05-061230 A (patent document 1) and JP 2001-018284 A (patent document 2)).

However, according to the studies made by the inventors of the present invention, it is recognized that the electrophotographic seamless belts manufactured by the stretch blow molding method have the following problems.

When a film thickness of the electrophotographic seamless belt such as the intermediate transfer belt or the transfer material transport belt is uneven, transfer uniformity on the belt may be lost to cause the color drift of an image or uniform transfer efficiency on the belt may not be obtained. Further, the running of the belt becomes unstable, so it is likely to reduce the durability of the belt. When the electrophotographic seamless belt is used as the intermediate transfer belt, it is constantly subjected to tension and repeatedly applied with bending and stretching stresses. Therefore, the intermediate transfer belt used for a long time may be broken or cracked. In addition, when the electrophotographic seamless belt is used as the intermediate transfer belt, it is likely to cause so-called creep in which a material is gradually stretched with time in a circumferential direction by the stresses. When a change in size which is cased by the creep is large, the size of the belt is changed from an initial design size to increase the color drift or cause an image defect such as an unevenness of a halftone image. The creep affects the rotation of the intermediate transfer belt in some cases, so that the creep becomes a large factor of shortening the life of the intermediate transfer belt.

In general, the precision of the outer size of the molded part obtained by the stretch blow molding method is improved using a molding die (hereinafter also referred to as a “blow die”). However, this method is a manufacturing method of supplying a high-pressure gas to a preform to expand and shape the molded part, so it is very difficult to uniform blowing during the blow molding. Therefore, it is likely to cause an unevenness in thickness. As described above, in the case of the electrophotographic seamless belt which is expected to obtain extremely high precision of thickness evenness, such an unevenness in thickness is a problem that must be solved.

However according to the conventional stretch blow molding method, it is difficult to form an electrophotographic seamless belt having no unevenness in film thickness.

Patent Document 1: JP 05-061230 A

Patent Document 2: JP 2001-018284 A

### DISCLOSURE OF THE INVENTION

Therefore, an object of the present invention is to provide a method capable of stably manufacturing an electrophotographic seamless belt at low cost which has an even film thickness, is excellent in size precision and durability, and ensures excellent image characteristics even when it is repeatedly used.

Another object of the present invention is to provide an electrophotographic apparatus capable of stably providing a high-quality electrophotographic image.

The inventors of the present invention have conducted various studies on the above-mentioned problems. As a result, the inventors have determined that an unevenness in thickness of a stretch-blow-molded part is caused by stress which is an internal force generated in a preform during a process in which the preform is subjected to stretch blowing. In the case of the stretch blowing, it is necessary to prevent the molded part or a half-molded part from breaking or cracking during the preform stretch-blowing process. Therefore, in the conventional stretch blow molding method, even when the preform is finally blown up to a state in which it is in contact with an inner surface of a die, a resin material and a stretch blow molding condition are experientially set in order for the resin to maintain a highly-flexible state. Here, the highly flexible state of the resin is a state in which the stress generated in the preform is low. In other words, a state in which the stress generated in the half-molded part is extremely low is set regardless of a stretch magnification. In this case, as described above, the molded part is prevented from breaking or cracking during the stretch blowing. However, even when an unevenness in thickness of the half-molded part is caused during the stretch blowing, there is little stress difference between a thick portion and a thin portion because the state in which the stress generated in the preform is low is set. Thus, the half-molded part is expanded with the unevenness in thickness thereof retained, with the result that it becomes the molded part in which the unevenness in thickness which is caused during the molding is reflected.

Then, the resin material and the stretch blow condition are set as appropriate by the inventors of the present invention so as to increase the stress generated in the half-molded part with an increase in stretch blow magnification. As a result, it is possible to obtain a molded part having an excellent thickness evenness. Such a phenomenon will be described with reference to FIG. 16. A preform 301 is stretched by a stretch rod 303 and then is expanded by air blowing to be molded in a seamless belt molding die (die for molding a seamless belt). A state in which the preform 301 begins to stretch is a state in which an amorphous thermoplastic resin (for example, a polyethylene naphthalate (hereinafter referred to as a “PEN”) resin) is heated at Tg or higher (for example, 145° C.), so the stress generated in the preform is low. Therefore, the preform 301 is ready to freely expand. When the preform 301 begins to freely expand, a large-expanded portion 304 and a small-expanded portion 305 are formed (state in which uneven expansion occurs). However, the large-expanded portion 304 of the preform (state in which a film thickness is thin) is in a high-stress state, so the preform expanded by air is hard to further expand. In contrast to this, the small-expanded portion 305 (portion whose film thickness is thick) is in a low-stress state. Here, a uniform air pressure is applied to an inner portion of the preform, so the small-expanded portion begins to expand and becomes thinner. As described above, the state in which the preform having the large film thickness is blown to reduce the film thickness thereof becomes a state in which the film thickness is constantly made even. This state is shown in FIG. 17. Even when the expansion is uneven at first, the preform finally expands to an even thickness. Because of such an effect, an expansion unevenness caused during the stretch blowing is canceled and a molded part having an even thickness is finally obtained. In other words, on the assumption that the resin material and the stretch blow condition are selected so as to prevent the molded part from bursting, an additional stretch blow condition is set so as to increase the stress generated in the half-molded part based on the stretch magnification for stretch blow. The inventors of the present invention found that a molded part having an even film thickness is thus obtained.

In other words, the present invention is as follows.

(1) A method of manufacturing an electrophotographic seamless belt, comprising: (i) a step of setting a substantially cylindrical preform, which is made of a thermoplastic resin mixture containing a thermoplastic resin and has an outer diameter “a”, in a seamless belt molding die including a cylindrical cavity having an inner diameter “b”, and performing stretch blow molding at a predetermined stretch temperature T1 to obtain a stretch-blow-molded part; and (ii) a step of cutting the stretch-blow-molded part obtained by the step (i) to obtain a seamless belt; wherein the thermoplastic resin mixture has a temperature T2 at which a parameter S/P calculated from a tensile-stress to strain curve obtained by performing a heat tensile test based on JIS K7161 on a sheet test piece made of the thermoplastic resin mixture becomes 2.0 to 15.0; and the temperature T2 is set as the predetermined stretch temperature T1 in the step (i),

(where P indicates stress when a stretch magnification of a test piece corresponds to 0.6×(b/a) in a case where a stretch magnification is 1 at an amount of strain of 0 on the tensile-stress to strain curve, S indicates stress when the stretch magnification of the test piece corresponds to 1.6×(b/a), and a value of (b/a)≧1.7)

(2) A method of manufacturing an electrophotographic seamless belt according to (1), wherein the value of (b/a) is in a range of 3.1 to 5.0.

(3) A method of manufacturing an electrophotographic seamless belt according to (2), wherein the value of (b/a) is in a range of 3.8 to 4.5.

(4) An electrophotographic apparatus, comprising: an electrophotographic photosensitive member including a support member; charging means for charging the electrophotographic photosensitive member; latent image forming means for forming an electrostatic latent image on the charged electrophotographic photosensitive member; developing means for visualizing the electrostatic latent image using a developer; and transfer means including primary transfer means for transferring the visualized image to the intermediate transfer belt and secondary transfer means for transferring the image which is transferred to the intermediate transfer belt to a transfer material; wherein the intermediate transfer belt is the electrophotographic seamless belt manufactured by the manufacturing method according to any one of (1) to (3).

(5) An electrophotographic apparatus according to (4), wherein the transfer means further includes cleaning means for charging a developer remaining on the intermediate transfer belt to a polarity opposite to that in primary transfer and returning the developer remaining on the intermediate transfer belt to the electrophotographic photosensitive member simultaneously with the primary transfer.

(6) An electrophotographic apparatus, comprising: an electrophotographic photosensitive member including a support member; charging means for charging the electrophotographic photosensitive member; latent image forming means for forming an electrostatic latent image on the charged electrophotographic photosensitive member; developing means for visualizing the electrostatic latent image using a developer; and transfer means including a transfer material transport belt for transporting a transfer material while the visualized image is transferred to the transfer material for each color; wherein the transfer material transport belt is the electrophotographic seamless belt manufactured by the manufacturing method according to any one of (1) to (3).

### BRIEF DESCRIPTION OF THE DRAWINGS

FIG. 1 is a schematic structural view showing, a four-process full-color electrophotographic apparatus using an electrophotographic seamless belt obtained by a manufacturing method according to the present invention as an intermediate transfer belt.

FIG. 2 is a schematic structural view showing a full-color electrophotographic apparatus of a four-successive-electrophotographic-photosensitive-member process using the electrophotographic seamless belt obtained by the manufacturing method according to the present invention as the intermediate transfer belt.

FIG. 3 is a schematic structural view showing a full color electrophotographic apparatus using the electrophotographic seamless belt obtained by the manufacturing method according to the present invention as a transfer material transport belt.

FIG. 4 is a graph showing an example of a stress to stretch-magnification curve.

FIG. 5 is a graph showing a change in the stress to stretch-magnification curve according to temperature.

FIG. 6 is a schematic view showing a manner of manufacturing a preform by injection molding.

FIG. 7 is a schematic view showing a manner of uniformly heating the preform by a heater.

FIG. 8 is an explanatory view showing uniform stretch blow molding.

FIG. 9 is an explanatory view showing the uniform stretch blow molding.

FIG. 10 is a schematic view showing a manner of taking out a part obtained by injection stretch blow molding.

FIG. 11 is a schematic view showing a manner of removing both ends of the part obtained by the injection stretch blow molding.

FIG. 12 is an explanatory view indicating a radial stretch magnification and a longitudinal stretch magnification.

FIG. 13 is a graph showing stress to stretch-magnification curves in examples.

FIG. 14 is a graph showing stress to stretch-magnification curves in comparative examples.

FIG. 15 shows a T-die molding apparatus for molding a test piece in a sheet shape used to obtain the stress to stretch-magnification curves.

FIG. 16 is an explanatory view showing a case where a seamless belt molding die having stress substantially equal to stress corresponding to a stretch magnification of 4 to 6 in a pattern 1 shown in FIG. 4 is used

FIG. 17 is an explanatory view showing the case where the seamless belt molding die having stress substantially equal to the stress corresponding to the stretch magnification of 4 to 6 in the pattern 1 shown in FIG. 4 is used.

FIG. 18 its an explanatory view showing a case where a seamless belt molding die having stress substantially equal to stress corresponding to a stretch magnification of 2 to 3 in the pattern 1 shown in FIG. 14 is used.

### BEST MODE FOR CARRYING OUT THE INVENTION

Hereinafter, a temperature and a stretch magnification during stretch blow molding with respect to a method of manufacturing an electrophotographic seamless belt according to the present invention will be described.

A “tensile-stress to strain curve” according to the present invention is obtained as follows. That is, a sheet sample thereinafter referred to as a “test piece”) which is identical to a preform used in the present invention is prepared by molding a thermoplastic resin mixture in a sheet shape using an extrusion apparatus. Then, the test piece is subjected to a heat tensile test based on a plastic tensile test according to JIS K7161-1994 to obtain the “tensile-stress to strain curve”.

In the present invention, a plurality of test pieces are prepared and the respective test pieces are heated at different temperatures to perform the heat tensile test. As a result, a tensile-stress to strain curve is obtained for each of the test pieces heated at the different temperatures. In examples described later, a temperature is changed every 5° C. in a range of 80° C. to 300° C. to obtain respective tensile-stress to strain curves.

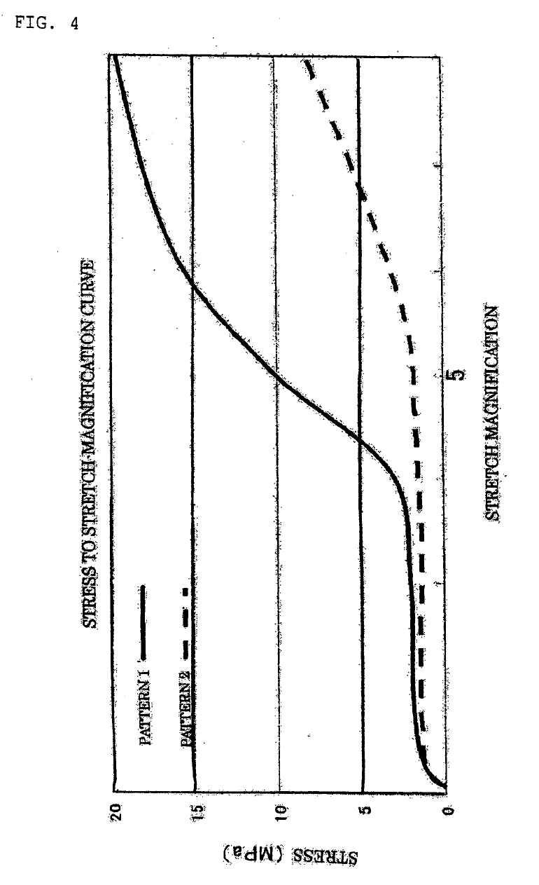

The curve will be described with reference to a pattern 1 shown in FIG. 4. In FIG. 4, the ordinate indicates the stress of a test piece and the abscissa indicates the strain of the test piece, that is, the stretch thereof, which is expressed here as the stretch magnification of the test piece. Therefore, the stretch magnification at an origin becomes 1.

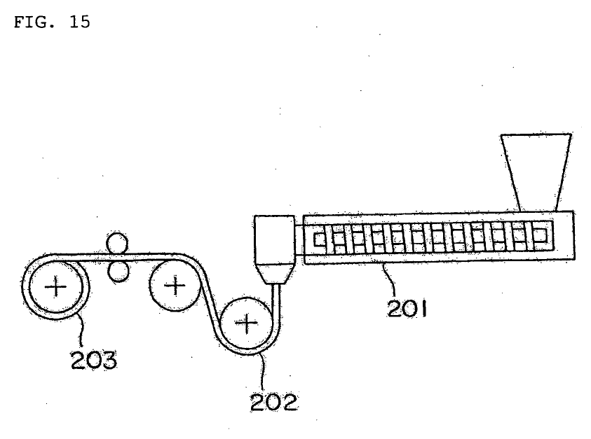

The stress to stretch-magnification curve shown in this figure is obtained as follows. A plurality of test pieces, in each of which a PEN resin which is a crystalline resin having a glass transition point of 118° C. is molded in a sheet shape using a T-die molding apparatus shown in FIG. 15 are prepared. The respective test pieces are heated at different temperatures equal to or higher than the glass transition point (hereinafter expressed by “Tg”). Then, a heat tensile test is performed in a uniaxial direction using a tensile test machine based on the JIS standards to obtain the stress to stretch-magnification curve.

A profile of the tensile-stress to strain curve related to a test piece at a temperature of 145° C. corresponds to the pattern 1 shown in FIG. 4. In the pattern 1, when the stretch-magnification is within a range of 2 to 3, a temperature of the PEN is equal to or higher than Tg (=118° C.). Therefore, molecules with an amorphous state are active, so that a film softens. Even when the heat tensile test is performed, the stress does not increase. Next, as is apparent from a change in stress within a stretch magnification range of 4 to 6, the stress gradually increases. This exhibits that molecular chains of the PEN begin to arrange in a stretch direction to shorten a distance between molecules, thereby causing molecular crystallization. That is, the molecular orientation is made to cause the crystallization, so that a state in which the resin is curing is obtained.

A preform is molded using a resin having a characteristic in which the stress significantly increases with an increase in stretch magnification. The stretch blowing is performed in a temperature condition in which a heating temperature of the preform is set to 145° C. while a size of a seamless belt molding die (stretch magnification) is changed. In such a case, the following phenomenon occurs. Note that 145° C. is a temperature at which the relation of the pattern 1 shown in FIG. 4 is obtained.

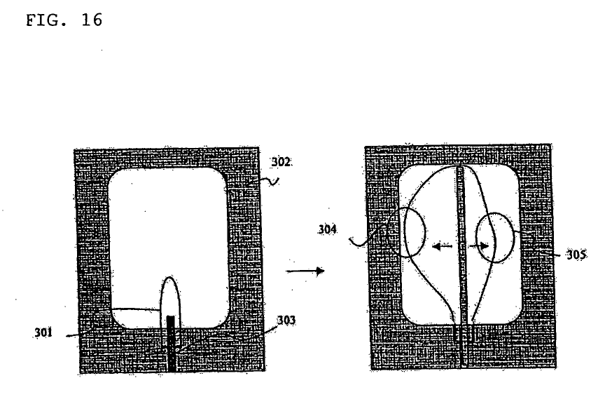

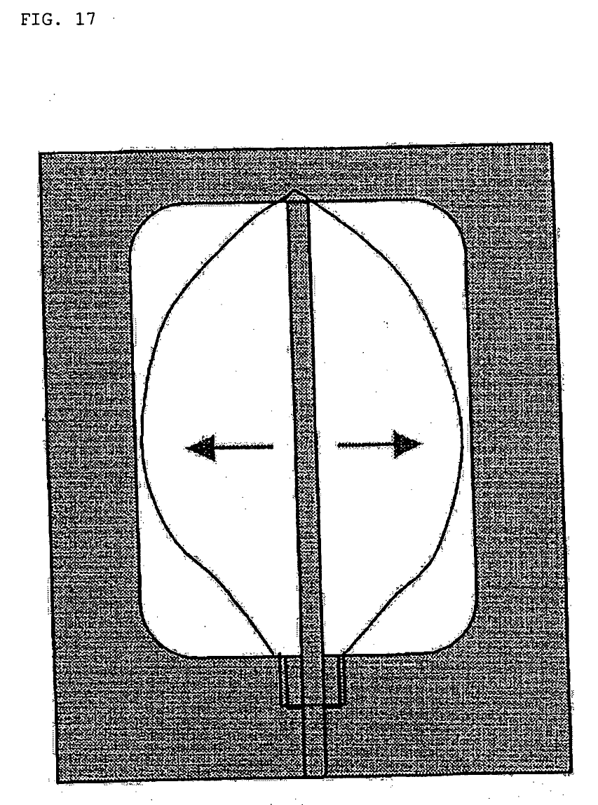

The phenomenon with respect to the case where a seamless belt molding die in which stress corresponding to a stretch magnification (b/a) after final blow molding is equal to that corresponding to the stretch magnification of 4 to 6 in the pattern 1 shown in FIG. 4 is used will be described with reference to FIG. 16. A preform 301 is stretched by a stretch rod 303. The stretched preform 301 expanded by air blowing to be molded in the seamless belt molding die. A state in which the preform 301 begins to stretch is a state in which an amorphous PEN resin is heated at Tg or higher (145° C.), so the stress generated in the preform is low. Therefore, the preform 301 is ready to freely expand. When the preform 301 begins to freely expand, a large-expanded portion 304 and a small-expanded portion 305 are formed (state in which uneven expansion occurs). However, when the large-expanded portion 304 of the preform (state in which a film thickness is thin) is under a stretched state corresponding to the stretch magnification within the range of 4 to 6 in the pattern 1 shown in FIG. 4 as described above, a state in which the preform is stretched to crystalline is obtained. This state is a large-stress state, so the preform expanded by air becomes a state in which it is hard to further expand. In contrast to this, the small-expanded portion 305 (portion whose film thickness is thick) is in a state in which the stretch magnification is low (for example, the stretch magnification of 2 to 3) in the pattern 1 shown in FIG. 4, so it is a small-stress state. Here, a uniform air pressure is applied to the inner portion of the preform, so the small-expanded portion begins to expand and becomes thinner. As described above, the state in which the preform having the large film thickness is blown to reduce the film thickness thereof becomes a state in which the film thickness is constantly made even. This state is shown in FIG. 17. Even when the expansion is uneven at first, the preform finally expands to an even thickness. Because of such an effect, an expansion unevenness caused during the stretch blowing is canceled and a thickness of a blow-molded part finally becomes even.

A reason why a parameter S/P obtained by performing the heat tensile test on a sheet sample is used in the present invention will be described. Note that a tensile direction in the heat tensile test to which the sheet sample is subjected is only a uniaxial direction, that is, uniaxial stretching is performed. In contrast to this, when actual stretch blowing is to be performed, the preform is extended in both the longitudinal and lateral directions, so this is biaxial stretching. The stresses in the biaxial directions during the stretching can be measured using, for example, a biaxial stretch test apparatus manufactured by Toyo Seiki Seisaku-Sho, Ltd. However, the measurement is complex and sample setting or the like takes a long time. On the other hand, in the case of the uniaxial stretching measurement, sample setting is easy to perform and many samples can be measured in a short time. Therefore, the inventors of the present invention examined a relationship between a stretch magnification and stress when the sheet sample is stretched in the uniaxial direction and a relationship between a stretch magnification and stress with respect to a stretch-blow-molded part obtained by stretching in the biaxial directions.

As a result, with respect to uniaxial stretching and biaxial stretching (stretch blowing), for example, in the case of a material and a temperature in which breaking occurs at a stretch magnification of 5 times in the uniaxial direction, when a stretch blow magnification (b/a) is 3.7 in a radial direction and 3.0 in a longitudinal direction (magnification obtained by multiplication of those is 11.1), molding is possible. However, for example, when the stretch blow magnification is 4.4 in the radial direction and 2.2 in the longitudinal direction (result obtained by multiplication of those is 9.68), breaking occurs, so that molding is impossible. Thus, the inventors of the present invention found that the uniaxial stretch magnification is not equal to the radial stretch magnification or the longitudinal stretch magnification at the time of the blow molding and the uniaxial directional stretch magnification of the sheet sampler is significantly sensitive to the lateral stretching (stretching in the radial direction) rather than the longitudinal stretching.

Then, the inventors of the present invention energetically examined a relationship between the uniaxial directional stretch magnification and the radial stretch magnification at the time of the blow molding. As a result, the inventors found the following.

1) A magnification in a low-stress state when uniaxial stretching is performed corresponds to a radial (lateral) stretch magnification (b/a) of 0.6 when blow molding is performed.

2) A magnification when the blow molding is performed to stretch the sheet sample up to a state in which it is in contact with an inner surface of a blow die corresponds to a radial (lateral) stretch magnification (b/a) of 1.6 at the time of the blow molding.

3) When a ratio of stresses generated in the diameter direction of the preform before and after stretching at the time of the blow-molding is set to 2 to 15, the evenness in film thickness is realized by a stress difference partially caused during a stretching process.

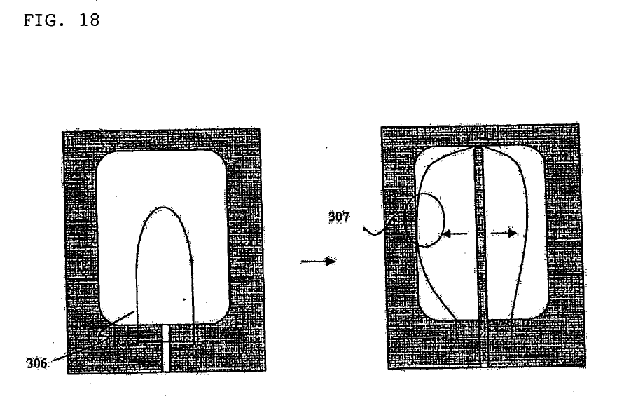

The case where a difference between stresses generated in the radial direction of the preform before and after stretching is insufficient even when stretch blow molding is performed using, for example, a PEN resin having the pattern 1 shown in FIG. 4 will be described. In such a case, a molded part having an even film thickness is not obtained. This case will be specifically described with reference to FIG. 18. Reference numeral 306 denotes a preform and its diameter is larger than that of the preform shown in FIG. 16. A large preform diameter means a low radial stretch magnification at blowing (for example, a stretch magnification is 2). In this case, the size of the preform becomes close to the size of the die. Therefore, when the blowing is preformed as shown in FIG. 18, a state 307 in which the preform is not significantly blown (significantly stretched) and is in contact with the blow die is obtained. That is, blowing is completed before a film thickness is made even by molecular orientation in a state which is the stretch magnification of 2 to 3 in the pattern 1 shown in FIG. 4, so the film thickness becomes uneven. When the radial stretch magnification at blowing is too high (for example, the stretch magnification exceeds 6), that is, when the size of the blow die is set to a very larger size than the size of the stretched preform, a test piece is cracked, so that the stress is becomes 0. As a result, the present invention cannot be realized.

On the other hand, a heating temperature of a test piece made of a PEN resin is increased from 145° C., a profile of the tensile-stress to strain curve as shown in the pattern 2 of FIG. 4 is obtained. When a heating temperature of the preform 301 is set to a temperature at which the profile of the pattern, 2 shown in FIG. 4 is obtained during a series of stretch blowing processes described with reference to FIG. 16, the following occurs. Even when the stretch magnification is 4 to 6, the stress generated in the preform hardly increases. Therefore, even when the preform is expanded by blowing and is in contact with the blow die, the stress generated in the preform does not increase. In addition, when the film thickness is thinned (significant stretching is made), the preform is under a state in which it can be further expanded, so an action for making the film thickness even by the stress difference does not occur. Even when the stretch blow molding is performed under such a state, only a molded part having a large unevenness in film thickness can be obtained.

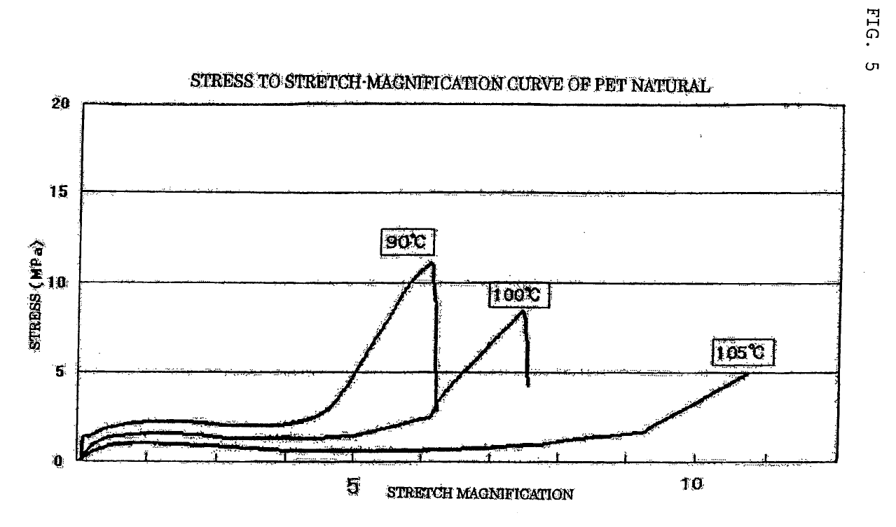

As described above, in order to make the film thickness even, there is an optimum stretch characteristic of a thermoplastic resin mixture. The stretch characteristic of the thermoplastic resin mixture is changed according to a molecular weight of a thermoplastic resin, other materials mixed in the thermoplastic resin mixture or temperature. Its example is shown in FIG. 5. A stress to stretch-magnification curve shown in FIG. 5 relates to the same material (polyethylene terephthalate resin (trade name: Mitsui PET J125)). However, the curve is changed according to a heating temperature. In the case of 90° C., the material is broken with a state in which the stretch magnification is lower than that in the case of 100° C., at about 6 times in this figure. When molding is performed using a blow die in a temperature condition of 90° C. at a stretch magnification of 6 or more, bursting may occur. On the other hand, in the case of 105° C., breaking occurs at a stretch magnification of about 11 times. However, the stress in the case of 105° C. at a magnification equal to the magnification when breaking occurs in the case of 100° C. (about 7.5 times in this figure) is lower than that in the case of 100° C. and does not change as compared with the case where the stretch magnification is 2 to 3. As is apparent from this figure, it is suitable to stretch the thermoplastic resin mixture and the blow die at 100° C. However, when molding is performed under the temperature condition of 105° C., the thermoplastic resin mixture is not burst but an unevenness in film thickness of the molded part occurs because the stress does not increase. Therefore, even in the case where the same material and the same die are used, when a suitable temperature to the stretch magnification is not set, the unevenness in film thickness occurs.

Thus, according to the present invention, it is necessary that the preform made of the thermoplastic resin mixture be subjected to stretch blow molding at a heating temperature at which S/P becomes 2.0 to 15.0 in view of the thermoplastic resin material and the stretch blow condition (temperature, magnification, and the like). When S/P is smaller than 2, the molecular orientation caused by stretching of the thermoplastic resin mixture becomes insufficient as compared with an actual radial stretch magnification, so that it is difficult to make the film thickness even and to improve the strength. This exhibits a stress to stretch-magnification curve having a small slope. When S/P is larger than 15, it is likely to cause longitudinal split, bursting or the like at the stretch blow molding, so that blow molding is difficult.

In the present invention, an S/P adjusting method includes temperature adjustment during blow molding, radial stretch magnification adjustment, and adjustment of the stretch characteristic of a thermoplastic resin mixture (selection of a suitable molecular weight of a thermoplastic resin, added material, and the like).

The temperature adjustment during blow molding is performed as follows. The thermoplastic resin mixture is formed in a sheet shape. After that, a heat tensile test based on JIS K7161 is performed every 5° C. in a range of 80° C. to 300° C. Then, a temperature at which a suitable S/P is obtained is detected based on tensile-stress to strain curves obtained corresponding to the respective temperatures to adjust the temperature during the blow molding.

With respect to the radial stretch magnification adjustment, a tensile-stress to strain curve obtained corresponding to an arbitrary temperature is used and an outer diameter of the preform and an inner diameter of a seamless belt molding die are adjusted such that S/P becomes 2 to 15. When the S/P value cannot be satisfied by only the adjustment of the outer diameter of the preform and the inner diameter of the seamless belt molding die using the tensile-stress to strain curve obtained corresponding to the arbitrary temperature, it is necessary to suitably adjust a temperature during stretching and a stretch characteristic of a thermoplastic resin mixture to be used. The stretch characteristic includes a composition, an intrinsic viscosity, and a melt mixing condition, as described latter.

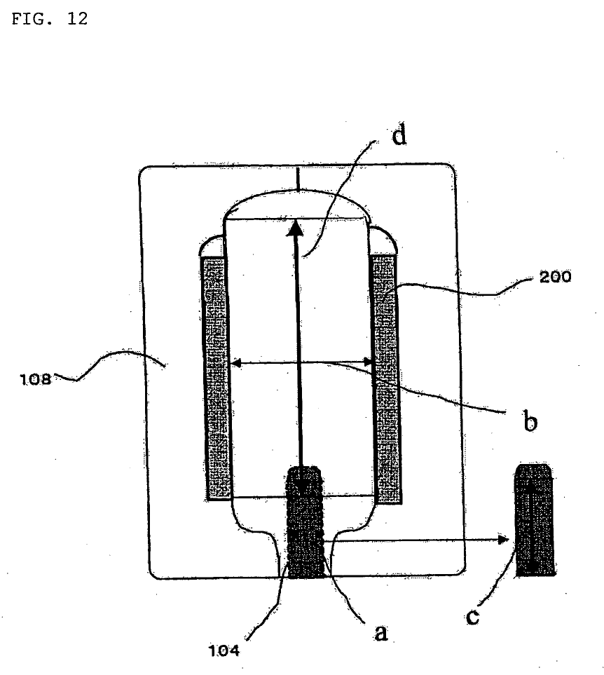

The radial stretch magnification is a ratio b/a between an outer diameter “a” of the preform and an inner diameter “b” of the seamless belt molding die as shown in FIG. 12, which are measured at the centers of the entire heights. A longitudinal stretch magnification is set as a ratio d/c of a longitudinal stretch portion d of the seamless belt molding die to a longitudinal stretch portion c of the preform.

In the present invention, in order to make the molecular orientation of the thermoplastic resin mixture caused by stretching sufficient to thereby attain the effect of the present invention, namely providing an electrophotographic seamless belt having an even thickness, it is necessary that the radial stretch magnification (b/a) be equal to or larger than 1.7. The stretch magnification is preferably in a range of 3.1 to 5.0. When it is smaller than 3.1, the stretch characteristic of the thermoplastic resin mixture may be suitably selected or the temperature condition during stretch blowing may be set such that stress generated in the preform becomes higher even in a state in which the stretch magnification is low in tensile-stress to strain curve. However, because the stretch magnification is small, a stress difference generated in the preform becomes larger by a slight change in difference of the amount of stretch between a portion which is stretched and a portion which is not stretched. Therefore, it is necessary to form the preform and the seamless belt molding die with very high shape precision. In the present invention, in order to realize an electrophotographic seamless belt, it is necessary that a film thickness of a molded part be set to 300 μm or less. However, when the stretch magnification (b/a) is smaller than 3.1, the thickness of the preform must be thinned, so that the thermoplastic resin mixture is hard to flow at the time of injection molding in some cases. When the thermoplastic resin mixture is hard to flow at the time of injection molding, uniform preform molding is difficult. Thus, the radial stretch magnification is preferably equal to or larger than 3.1.

On the other hand, in the case where the stretch magnification (b/a) is made larger than 5.0, even when a thermoplastic resin mixture containing mainly a thermoplastic resin having a stretch characteristic in which stretch is large is used, a sufficient stretch characteristic is not obtained to cause bursting in some cases. This is because the stretch characteristic is inhibited by other additive agents mixed in the thermoplastic resin mixture in many cases. In addition, when the stretch magnification is larger than 5.0, the preform is significantly stretched, so it is necessary to widen a stretch magnification section which is under an amorphous state, that is, a stretch magnification section with a low-stress state. To realize this, a preform temperature may be increased. However, when the temperature is increased, crystallization without stretching tends to be caused, that is, spherulite is likely to be obtained in some cases, so that stretching may be unstable. Therefore, it is preferable that the radial stretch magnification be equal to or smaller than 5.0. A particularly preferable radial stretch magnification is in a range of 3.8 to 4.5. When the radial stretch magnification is within such a range, it can be expected to further improve the film thickness precision (suppress unevenness in film thickness).

In the seamless belt manufacturing method of the present invention, it is preferable that the longitudinal stretch magnification (d/c) is in a range of 1.5 to 3.5. When it is smaller than 1.5, there is the case where the preform is thinned and thus molding is difficult. When it is larger than 3.5, a longitudinal shrinkage force becomes stronger, so a molding property may be unstable. The stretch magnification (d/c) is preferably in a range of 2.0 to 3.0. It is preferable that a value obtained by multiplying the radial stretch magnification (b/a) by the longitudinal stretch magnification (d/c) becomes in a range of 7 to 15. When it is smaller than 7, there is the case where the preform is thinned and thus molding is difficult. When it is larger than 15, the entire stretch becomes larger, so it may be difficult to design a material having a tensile-stress to strain curve in which it is resistive to burst.

A thermoplastic resin for the thermoplastic resin mixture used in the present invention is particularly not limited when it produces the thermoplastic resin mixture having the characteristic in which S/P is in a range of 2.0 to 15.0. A resin which becomes an amorphous state at a time when the preform is molded is particularly preferable. For example, there are PEN, PET, MX nylon and the like. These resins are rapidly cooled when the preform is obtained by injection molding or the like, so that the amorphous state can be maintained. Crystallization can be caused by stretching during the stretch blowing, so an increase in stress during stretching can be realized.

The adjustment of such a characteristic of the thermoplastic resin mixture includes, for example, a method of adjusting an intrinsic viscosity [η] when the thermoplastic resin mainly contained in the thermoplastic resin mixture is PEN or PET. For example, when the S/P value becomes larger than 15, PEN or PET whose intrinsic viscosity [η] value is small (for example, 0.6 or less) is preferably used. Therefore, a molecular weight of PEN or PET becomes lower, so that an increase in stress during stretching can be suppressed and the S/P value can be adjusted to 15 or less.

When the S/P value becomes smaller than 2, PEN or PET whose intrinsic viscosity [η] value is large (for example, 0.8 or more) is preferably used. In such a case, the molecular weight becomes higher, so that the stress during stretching can be increased and the S/P value can be adjusted to 2 or more.

It is preferable that the intrinsic viscosity [η] of the PEN resin or the PET resin be 0.5 to 2.0. This is because the tensile stress at a stress temperature becomes adequate to a blow pressure when the intrinsic viscosity [η] is 0.5 to 2.0, so that uniform stretching is possible. When the intrinsic viscosity [η] is smaller than 0.5, the tensile stress becomes too high, so stretch molding itself is difficult. Therefore, it is not preferable. When the intrinsic viscosity [η] is larger than 2.0, the stress of the stretched thermoplastic resin mixture becomes lower, so the sufficient molecular orientation is not obtained. Therefore, uniform stretching is difficult, so that it is not preferable.

The intrinsic viscosity of PEN or PET can be adjusted by time adjustment at the time of polymerization or temperature control at the time of polymerization. With respect to a resin which has subjected to polymerization, the intrinsic viscosity thereof is adjusted by strong mixing using a method of increasing rpm of a screw at the time of compounding or reducing a temperature.

An intrinsic viscosity [η] measuring method is executed based on JIS K7367.

For example, the intrinsic viscosity [η] of PET can be measured as follows. First, the PET is diluted (melted) with mixed solvent having a mass ratio between phenol and 1,1,2,2-tetrachloroethane is 60:40. Then, a viscosity η of a diluted sample and a viscosity η0 of the solvent are measured in a condition of 25° C. by an Ubbelohde viscometer. Then, a specific viscosity (ηsp) is calculated by the following expression (2) and the intrinsic viscosity [η] is calculated by the expression (3).

$$\begin{matrix}{η}_{sp} = ( η - {η}_{0} ) / {η}_{0} & ( 2 ) \\ [ Formula 1 ] \\ [ η ] = {lim}_{c \to O} \frac{{η}_{SD}}{c} & ( 3 )\end{matrix}$$

Here, it is assumed that c is a dilution concentration c (g/100 ml) of the solvent.

With respect to another method of adjusting the stretch characteristic of the thermoplastic resin mixture containing a crystalline thermoplastic resin such as PEN or PET, also by using a resin having a high melt flow rate value, the S/P value can be adjusted to 15 or less. Further, also by using a mixing condition for compounding the thermoplastic resin mixture, the S/P value can be adjusted to 15 or less. For example, the molecular weight can be reduced by strong mixing using a method of increasing the rpm of a screw at the time of compounding, reducing a temperature, or the like with the result that the S/P value can be adjusted to 15 or less.

In the case where the S/P value is to be adjusted to 2 or more, also by using a resin having a low melt flow rate value, the S/P value can be adjusted to 2 or more. Further, even when a mixing condition for compounding the thermoplastic resin mixture is changed, the S/P value can be adjusted to 2 or more. For example, a reduction in molecular weight can be prevented by weak mixing using a method of reducing the rpm of a screw at the time of compounding, increasing a temperature, or the like with the result that the S/P value can be adjusted to 2 or more.

The case of the crystalline resin such as PEN or PET is described. Even when a non-crystalline resin is mixed with various additive agents to detect a temperature T2 at which S/P is in a range of 2 to 15 and a stretch temperature T1 is set to T2, the effect of the present invention can be obtained.

In addition, with respect to the crystalline resin, polypropylene, polyacetal, and polybutylene terephthalate are crystallized at a time when the preform is molded. The crystals of these resins are easily deformed as compared with the crystals of PEN and PET. Therefore, even when the resins are crystallized without being in the amorphous state, the stretch magnification is substantially equal to that of PEN or PET which is in the amorphous state when the preform is molded. However, because the stress at a P point (stretch magnification of the test piece is 0.6×(b/a)) is high in only each of these thermoplastic resins, it is impossible that S/P satisfies a range of 2 to 15, so that it is difficult to produce a belt having an even film thickness. On the other hand, when the thermoplastic resin such as polypropylene, polyacetal, or polybutylene terephthalate is mixed with thermoplastic elastomer and then used as the thermoplastic resin mixture, the stress at the P point can be reduced. Thus, even when the crystalline resin which has crystallized at a time when the preform is molded is used, the film thickness can be made even by molding using polypropylene, polyacetal, or polybutylene terephthalate by causing the thermoplastic elastomer to be contained in the thermoplastic resin mixture. For example, the following is used as the thermoplastic elastomer.

Examples of the thermoplastic elastomer include a polyethylene-based elastomer, a polyolefine-based elastomer, a polyester-based elastomer, a polyurethane-based elastomer, a polyamide-based elastomer, and a fluorine-containing polymer-based elastomer.

Examples of another thermoplastic resin to be used for a preform include an olefine-based resin, a polystyrene-based resin, an acrylic resin; an ABS resin, polyester resins such as PBT and PAR, a polycarbonate resin, sulfur-containing resins such as polysulfone, polyether sulfone, and polyphenylene sulfide, fluorine atom-containing resins such as polyvinylidene fluoride and a polyethylene-tetrafluoroethylene copolymer, a polyurethane resin, a ketone resin, polyvinylidene chloride, a polyamide resin, a denatured polyphenylene oxide resin, denatured resins of those, and copolymers of those.

One kind off or two or more kinds of thermoplastic resins can be used for the preform.

The “thermoplastic resin mixture” used in the present invention is a resin mixture having thermal plasticity. For example, even in the case of a mixture of the thermoplastic resin and a thermosetting resin resin powder, when a resultant resin mixture has thermal plasticity, such a mixture is referred to as the thermoplastic resin mixture.

It is preferable that an elastic coefficient of the electrophotographic seamless belt in the present invention be equal to or larger than 10 MPa. This reason is as follows. In the case where it is equal to or larger than 10 MPa, stretch is small even when the belt is rotated, so an image shift becomes smaller and an unevenness in image density reduces.

Volume resistivity of the electrophotographic seamless belt in the present invention may be controlled for purposes. With respect to a method of controlling the volume resistivity, it is preferable for the thermoplastic resin mixture used for the preform to contain a conductive resin. The conductive resin is easily uniformly mixed with the mainly contained thermoplastic resin, with the result that the volume resistivity is easily stabilized. The conductive resin used in the present invention includes polyetheresteramide and a mixture thereof and polyetherester and but is not limited to those. For example, the following material serving as a material having conductivity instead of the conductive resin may be contained in the thermoplastic resin mixture.

Examples of the material include a tetraalkylammonium salt, trialkyl benzyl, an ammonium salt, sulfonate, alkylsulfate, a glycerin fatty acid ester, a sorbitan fatty acid ester, polyoxyethylene alkylamine, a polyoxyethylene fatty alcohol ester, alkyl betaine, and lithium perchlorate.

In particular, because a balance between the conductivity and a bleeding property can be realized, potassium perfluorobutane sulfonate which is sulfonate is particularly preferable.

With respect to a range of the volume resistivity of the electrophotographic seamless belt, in the case of an intermediate transfer belt, a range of the volume resistivity for obtaining a preferable image is preferably 1×10⁶ Ω·cm to 8×10¹³ Ω·cm. When the volume resistivity is lower than 1×10⁶ Ω·cm, because the volume resistivity is too low, a sufficient transfer electric field cannot be obtained, so image blanking and roughing occur. On the other hand, when the volume resistivity is higher than 8×10¹³ Ω·cm, it is necessary to set a high transfer voltage, so that increases in power source size and cost occur in some cases. In the case of a transfer material transport belt, because it is necessary to attract and transport a transfer material such as a paper sheet, a preferable range of the volume resistivity is 1×10⁸ Ω·cm to 5×10¹⁴ Ω·cm. Even when it is outside this range, the transfer can be performed in a certain transfer process, so that the volume resistivity is not necessarily limited to the above-mentioned range. In the case of a support member of an electrophotographic photosensitive member, a preferable range of the volume resistivity is equal to or lower than 1×10⁴ Ω·cm. Note that, in the case where the support member of the electrophotographic photosensitive member has 1×10⁵ Ω·cm or higher, when a surface thereof is subjected to metal evaporation or coated with a conductive coating by application to reduce the volume resistivity to 1×10⁴ Ω·cm or lower, the volume resistivity may be 1×10⁵ Ω·cm or higher.

It is preferable that the film thickness (thickness) of the electrophotographic seamless belt used as the intermediate transfer belt or the transfer material transport belt be in a range of 40 μm to 250 μm. When it is smaller than 40 μm, molding is unstable, the unevenness in film thickness is likely to cause, and an endurance strength is insufficient. In some cases, breaking or splitting of the belt occurs. On the other hand, when the film thickness exceeds 250 μm, the number of materials and a cost increase. In addition, a peripheral velocity difference between an inner surface and an outer surface in a loop-around shaft portion of a printer or the like becomes larger, so that it is likely cause a problem such as image scattering due to the shrinkage of the outer surface. Further, drive torque is increased by reduced, bending endurance and very high stiffness of the belt, so that there is a problem in that increases in main body size and cost occur.

It is preferable that the film thickness of the support member of the electrophotographic photosensitive member be in a range of 40 μm to 250 μm. When it is smaller than 40 μm, molding is unstable the unevenness in film thickness is likely to occur, and an endurance strength is insufficient. In some cases, breaking or splitting of the belt occurs. On the other hand, when the film thickness exceeds 250 μm, the number of materials and a cost increase. In addition, drive torque is increased by very high stiffness of the belt, so that there is a problem in that increases in main body size and cost occur.

It is preferable that the unevenness in film thickness of the electrophotographic seamless belt used in the present invention be within 10%. When it exceeds 10%, the nonuniform running speed is generated while the belt is running, thereby causing an unevenness in image density in some cases. A more preferable range is within 5%. In the case of a transfer material transport belt for an electrophotographic apparatus of a type in which a plurality of electrophotographic photosensitive members are arranged in parallel, even when there is a slight speed difference, an unevenness in image density is caused. Therefore, when using particularly the transfer material transport belt, the unevenness in film thickness is preferably within 5%.

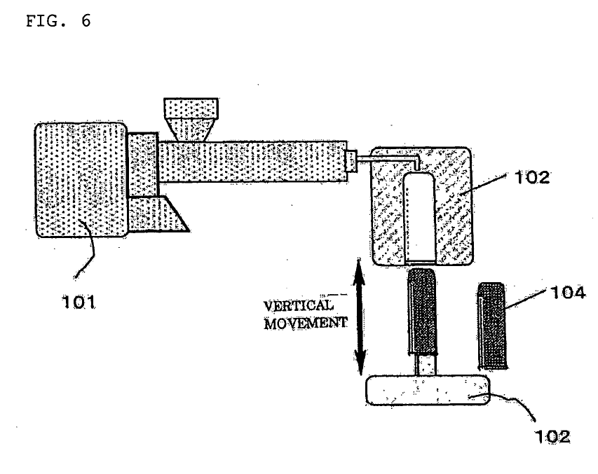

An example of a stretch blow molding method in a method of manufacturing the electrophotographic seamless belt according to the present invention will be described with reference to FIG. 6 to 11.

FIG. 6 shows a process for performing injection molding on a preform used for stretch blow molding. First, a preform 104 which is a test tube shaped molded part in this figure is molded by injection molding.

That is, a belt material in which a thermoplastic resin mixture containing a thermoplastic resin and a conductive material is uniformly mixed and dispersed in advance is injected to an injection molding die 102 by an extrusion machine 101 to obtain the preform 104. The injection molding die 102 is movable up or down.

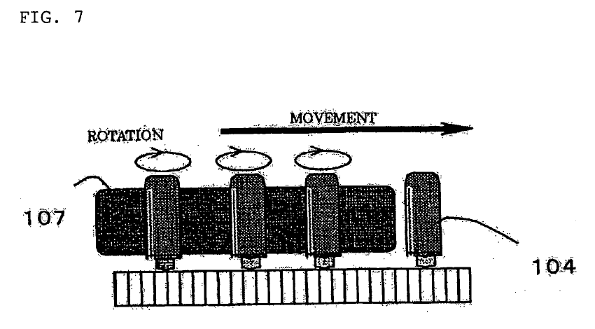

After the preform is obtained by the injection molding as described above, the preform is heated up to a heating temperature for stretch blow molding. More specifically, in a heating process shown in FIG. 7, the preform 104 is heated to a desirable temperature while it is continuously moved through a heating furnace 107. The heating temperature can be suitably set according to a blow die structure (radial stretch magnification) and/or a belt material (stretch characteristic of the thermoplastic resin mixture.)

The heating furnace 107 may include one or plural heaters provided on both sides or one side thereof and may be a hot-air furnace or a warm-air furnace. It is preferably a heating furnace in which a heater is provided. The heater can use hot-wire heating, halogen-heater heating, infrared heating, electromagnetic induction heating, or the like. The halogen-heater heating, the infrared heating, and the electromagnetic induction heating are preferable because heating can be performed at low system cost.

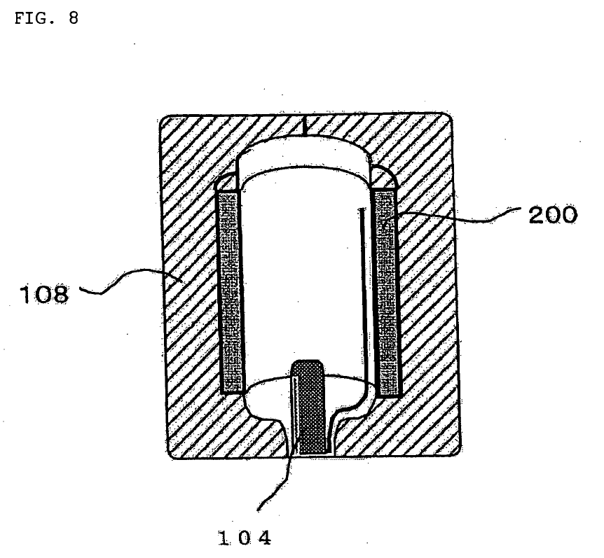

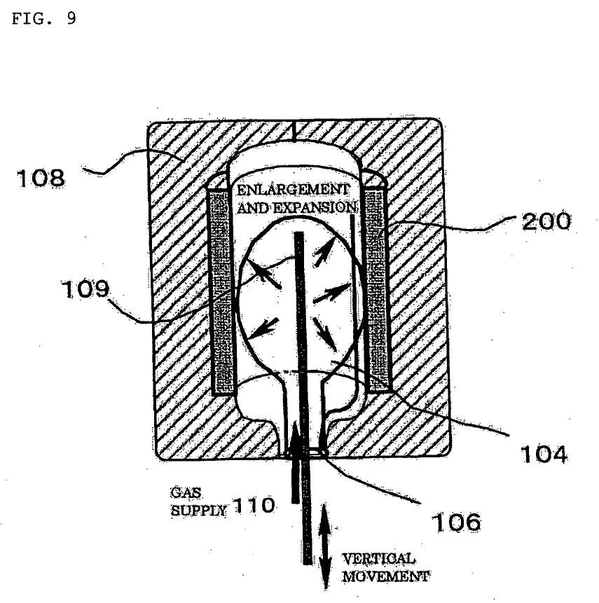

After the molding of the preform and the heating of the preform, the stretch blow molding is performed as shown in FIGS. 8, 9, and 10. After heating, the preform 104 is placed in a blow die (having a cylindrical cavity) as shown in FIG. 8, stretched in a longitudinal direction by a stretch rod 109 and a primary air pressure as shown in FIG. 9, and molded by a secondary air pressure so as to expand along an inner surface of the blow die. As shown in FIG. 8, it is preferable that the blow die have a cylindrical die 200 so as to prevent a surface of a seamless belt from becoming uneven during the stretch blow molding.

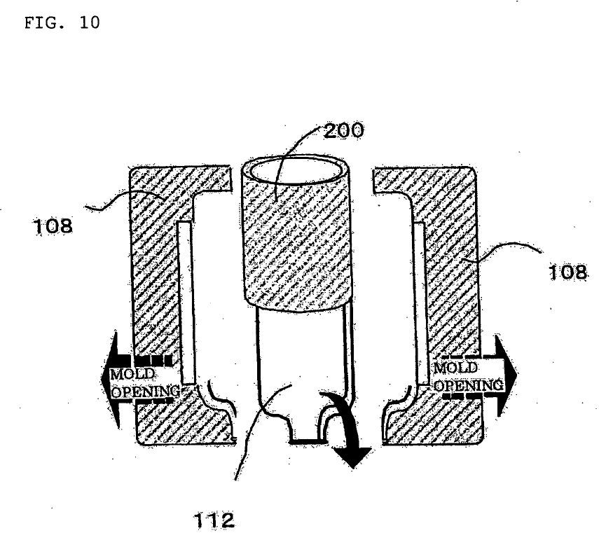

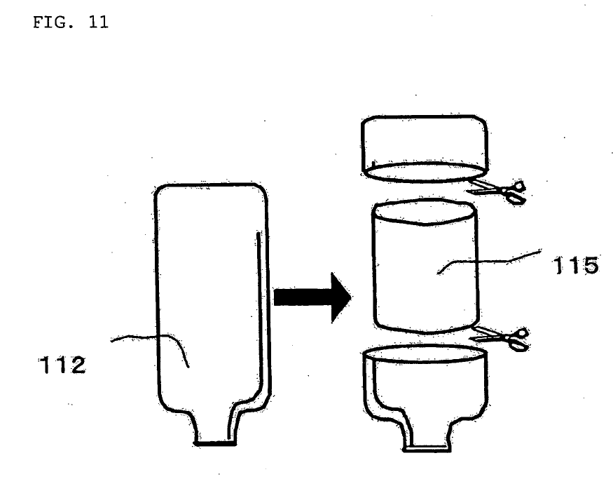

Then, as shown in FIG. 10, the blow die 108 is opened to remove the cylindrical die 200, thereby taking out a stretch-blow-molded part 112. Finally, upper and lower portions of the stretch blow-molded part 112 obtained as shown in FIG. 11 are cut, so that an electrophotographic seamless belt 115 according to the present invention can be obtained.

At this time, when the film thickness of the obtained electrophotographic seamless bait is to be set in a desirable range, the thickness of the preform may be adjusted. That is, when the preform is thickened, the belt becomes thicker. When the preform is thinned, the belt becomes thinner. The thickness of the belt can be adjusted by the adjustment of the stretch magnification. This means as follows. In the case where the thickness of the preform is even, when the stretch magnification increases, the belt becomes thinner, when the stretch magnification reduces, the belt becomes thicker.

Next, an electrophotographic apparatus having the electrophotographic seamless belt obtained by the manufacturing method according to the present invention will be described by giving specific examples thereof.

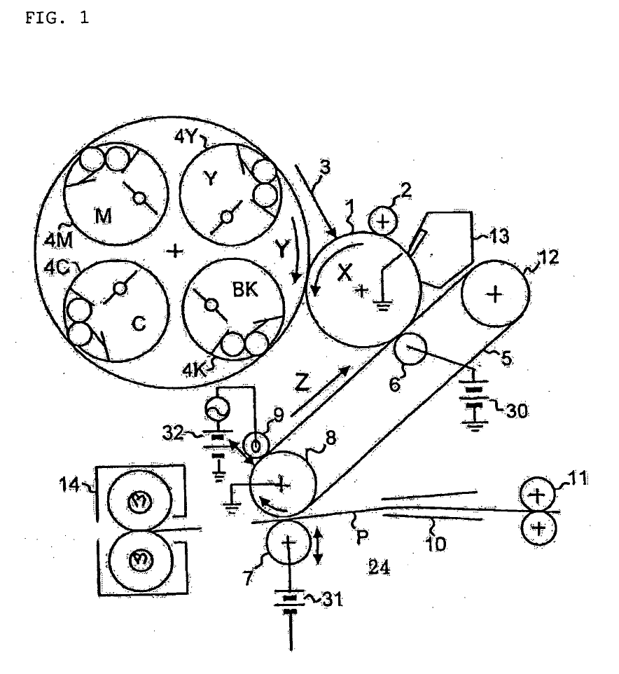

FIG. 1 is a schematic structural view showing a four-process full-color electrophotographic apparatus using the electrophotographic seamless belt according to the present invention as the intermediate transfer belt.

In FIG. 1, a cylindrical electrophotographic photosensitive member 1 is rotated in a direction indicated by an arrow X at predetermined peripheral speed (process speed). The electrophotographic photosensitive member 1 is uniformly charged to a predetermined polarity and a predetermined potential by a primary charger 2 during a rotational process. Then, the electrophotographic photosensitive member 1 is subjected to exposure (image exposure) 3 from an exposure means (not shown) serving as a latent image forming means, so that an electrostatic latent image corresponding to a first color component image (for example, a yellow color component image) of a target color image is formed. The exposure means includes slit exposure, laser beam scanning exposure, and LED exposure.

Then, the electrostatic latent image is developed using yellow toner Y as a first color by a first developing device (yellow developing device 4Y). At this time, each of second to fourth developing devices (magenta developing device 4M, cyan developing device 4C, and black developing device 4K) is in an operation-off-state and does not act to the electrophotographic photosensitive member 1. A yellow toner image of the first color is not affected by the second to fourth developing devices.

An intermediate transfer belt 5 is rotated in the direction indicated by an arrow Z at peripheral speed substantially equal to that of the electrophotographic photosensitive member 1 (for example, 97% to 103% of the peripheral speed of the electrophotographic photosensitive member 1). The yellow toner image of the first color, which is formed and borne on the electrophotographic photosensitive member 1 is primary-transferred to an outer peripheral surface of the intermediate transfer belt 5 during a process in which the image passes through a nip portion between the electrophotographic photosensitive member 1 and the intermediate transfer belt 5. The primary transfer is performed by an electric field produced by a primary transfer bias applied from a primary transfer member (primary transfer roller) 6 to the intermediate transfer belt 5. The primary transfer bias has a polarity opposite to that of toner and applied from a bias power source 30. An applied voltage is in a range of +100 V to +2 kV, for examples. The surface of the electrophotographic photosensitive member 1 after the transfer of the yellow toner image of the first color corresponding to the intermediate transfer belt 5 is cleaned by a cleaning member 13.

Similarly, a magenta toner image of a second color, a cyan toner image of a third color, and a black toner image of a fourth color are successively transferred to the intermediate transfer belt 5 to superimpose them thereon. Therefore, a composite color toner image corresponding to the target color image is formed.

A secondary transfer member (secondary transfer roller) 7 is placed in a state where the secondary transfer member is borne in parallel corresponding to a secondary transfer opposite roller 8 and can be separated from a lower surface portion of the intermediate transfer belt 5. Reference numeral 12 denotes a loop-around roller. The secondary transfer member 7 can be separated from the intermediate transfer belt 5 during a primary transfer process of the toner images of the first to third colors from the electrophotographic photosensitive member 1 to the intermediate transfer belt 5.

The composite color toner image transferred onto the intermediate transfer belt 5 is secondary-transferred to a transfer material P which passes though a transfer material guide 10 from feed rollers 11 and is fed to a contact nip located between the intermediate transfer belt 5 and the secondary transfer member 7 at a predetermined timing in synchronization with the rotation of the intermediate transfer belt 5. The secondary transfer is performed by a secondary transfer bias applied from the secondary transfer member 7. An applied voltage of the secondary transfer bias is, for example, in a range of +100 V to +2 kV.

The transfer material P to which the toner image is transferred is led to a fixing unit 14 and is thermally fixed for image output. After the completion of the image transfer to the transfer material P, a cleaning charge member 9 is made in contact with the intermediate transfer belt 5. A bias having a polarity opposite to that of the bias applied to the electrophotographic photosensitive member 1 is applied to the cleaning charge member 9. Therefore, a charge having polarity opposite to that of a charger applied to the electrophotographic photosensitive member 1 is applied to toner remaining on the intermediate transfer belt 5 without being transferred to the transfer material P (transfer residual toner). Reference numeral 32 denotes a bias power source. The transfer residual toner in the nip portion with the electrophotographic photosensitive member 1 and its vicinities is electrostatically transferred to the electrophotographic photosensitive member 1, thereby cleaning the intermediate transfer belt 5.

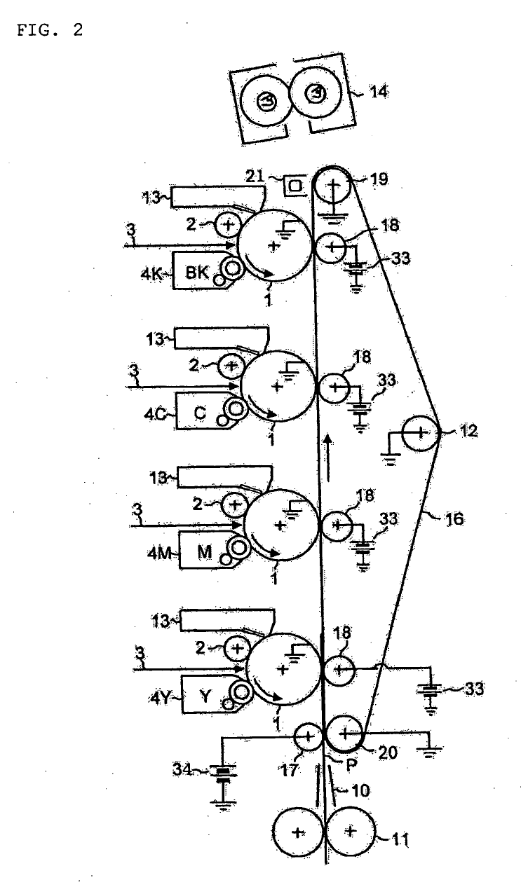

FIG. 2 is a schematic structural view showing a full-color electrophotographic apparatus using the electrophotographic seamless belt according to the present invention as the transfer material transport belt.

The electrophotographic apparatus shown in FIG. 2 includes four image forming portions arranged as electrophotographic process means. Each of the image forming portions includes the electrophotographic photosensitive member 1, the primary charger 2, the developing device 4, and the cleaning member 13. Note that the developing devices 4Y, 4M, 4C, and 4K contain yellow (Y) toner, magenta (M) toner, cyan (C) toner, and black (BK) toner, respectively.

In each of the image forming portions, the electrophotographic photosensitive member 1 is rotated in a direction indicated by each arrow at predetermined speed. The electrophotographic photosensitive member 1 is uniformly charged to predetermined polarity and a predetermined potential by the primary charger 2. The charged electrophotographic photosensitive member 1 is subjected to the exposure 3 outputted from the exposure means (not shown) as described above, so that an electrostatic latent image corresponding to each color component image of a target color image is formed. The respective electrostatic latent images are developed by the developing devices 4Y, 4M, 4C, and 4K to visualize as a yellow toner image, a magenta toner image, a cyan toner image, and a black toner image, respectively.

The respective color toner images, the yellow, magenta, cyan, and black toner images, which are formed and borne on the electrophotographic photosensitive member 1 are transferred by being superimposed on one another while the transfer material P passes through the respective image forming portions. Therefore, a composite color toner image corresponding to the target color image is formed. The transfer is performed by a transfer bias applied from a transfer member (transfer roller) 18. The transfer material P passes through the transfer material guide 10 from the feed rollers 11 and is attracted to a transfer material transport belt 16, so that it is moved together therewith and passes through the respective image forming portions. The transfer bias has polarity opposite to that of toner and is applied from a bias power source 33. An applied voltage is, for example, in a range of +100 V to +2 kV.

The recording paper P to which the respective color toner images are transferred as described above is subjected to charge elimination by a separation charger 21 and removed from the transfer material transport belt 16, and then transported to the fixing unit 14. The color toner images are thermally fixed for image output.

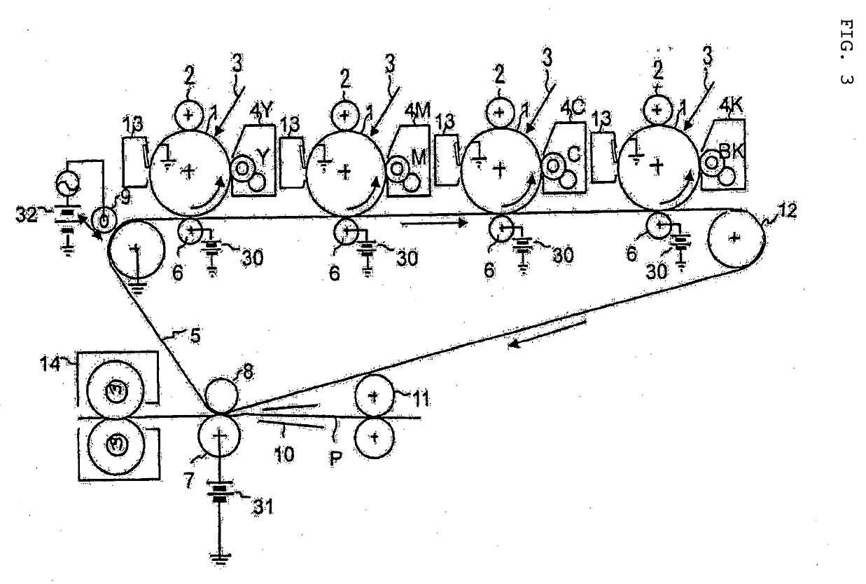

FIG. 3 is a schematic structural view showing a full-color electrophotographic apparatus of a quadruple electrophotographic photosensitive member system using the electrophotographic seamless belt according to the present invention as the intermediate transfer belt.

The electrophotographic apparatus shown in FIG. 3 includes four image forming portions arranged as electrophotographic process means. Each of the image forming portions includes the electrophotographic photosensitive member 1, the primary charger 2, the developing device 4, and the cleaning member 13. Note that the developing devices 4Y, 4M, 4C, and 4K contain yellow (Y) toner, magenta (M) toner, cyan (C) toner, and black (BK) toner, respectively.

In each of the image forming portions, the electrophotographic photosensitive member 1 is rotated in a direction indicated by each arrow at predetermined speed. The electrophotographic photosensitive member 1 is uniformly charged to predetermined polarity and a predetermined potential by the primary charger 2. The charged electrophotographic photosensitive member 1 is subjected to the exposure 3 outputted from the exposure means (not shown) as described above, so that an electrostatic latent image corresponding to each color component image oaf a target color image is formed. The respective electrostatic latent images are developed by the developing devices 4Y, 4M, 4C, and 4K to visualize as a yellow toner image, a magenta toner image, a cyan toner image, and a black toner image, respectively.

The intermediate transfer belt 5 is rotated clockwise at peripheral speed (for example, 97% to 103% of the peripheral speed of the electrophotographic photosensitive member 1) substantially equal to that of the electrophotographic photosensitive member 1.

The respective color toner images which are formed and carried on the electrophotographic photosensitive member 1 are transferred by superimposition (primary-transferred) to the outer peripheral surface of the intermediate transfer belt 5 while the images pass through the nip portion between the electrophotographic photosensitive member 1 and the intermediate transfer belt 5. Therefore, a composite color toner image corresponding to the target color image is formed. The primary transfer is performed by the primary transfer bias applied from the primary transfer member (primary transfer roller) 6 to the intermediate transfer belt 5. The primary transfer bias has polarity opposite to that of toner and is applied from the bias power source 30. An applied voltage is, for example, in a range of +100 V to +2 kV.

The secondary transfer member (secondary transfer roller) 7 is placed in a state where the secondary transfer member is borne in parallel corresponding to the secondary transfer opposite roller 8 and can be separated from the lower surface portion of the intermediate transfer belt 5. Reference numeral 12 denotes a tension roller.

The composite color toner image transferred onto the intermediate transfer belt 5 is transferred (secondary-transferred) by the secondary transfer bias applied from the secondary transfer member 7 to the transfer material P which passes though the transfer material guide 10 from the feed rollers 11 and is fed to the contact nip located between the intermediate transfer belt 5 and the secondary transfer member 7 at a predetermined timing in synchronization with the rotation of the intermediate transfer belt. An applied voltage of the secondary transfer bias is in a range of +100 V to +2 kV, for example.

The transfer material P too which the toner image is transferred is led to the fixing unit 14 and thermally fixed for image output. Toner remaining on the intermediate transfer belt is collected by the cleaning charge member 9 as in the case shown in FIG. 1.

Hereinafter, methods for measuring various physical properties with respect to the present invention will be described.

<Tensile-Stress to Strain Curve Measuring Method>

Sheet Sample Manufacturing Method

A thermoplastic resin mixture is injected into a hopper of a uniaxial T-die extrusion apparatus 201 as shown in FIG. 15 and uniaxial melt extrusion is performed for sheet melt extrusion from the T-die. The thermoplastic resin mixture extruded with a melt state is rapidly cooled by contact with a cooling roll 202. A cooling roll temperature is changed according to a type off the thermoplastic resin mixture. In the case of a crystalline resin, in order to inhibit crystallization, it is preferably formed at 20° C. or lower. The cooled sheet is wound by a winding roller 203. A thickness of the sheet used in the present invention is preferably 70 μm to 190 μm. The thickness is controlled based on the amount of extrusion and the rotation speed of the winding roller 203. The sheet sample obtained by the above-mentioned method is subjected to a heat tensile test based on the following size and the following condition.

Heat Tensile Test Condition

The heat tensile test in the present invention is executed based on JIS K7161.

A specific manner is as follows.

Evaluation Apparatus: UCT-500 (Orientec Co., Ltd.)

Furnace Temperature: up to 300° C.

Sheet Sample Size: 70 μm to 190 μm in thickness, 20 mm in width, and 100 mm in height

Distance between Chucks: 20 mm

Tensile speed: 500 mm/min.

Note that, when the film thickness of a molded part is not in the above-mentioned range, it is difficult to execute the accurate heat tensile test.

(1) When the evaluation apparatus is started up, the furnace temperature is set to any temperature in the range of 80° C. to 300° C. at intervals of 5° C. After the temperature in the furnace reaches a predetermined temperature, it preheated for 5 minutes.

(2) After that, the sample is held by the chuck and the furnace temperature is increased to the predetermined temperature again. After an increase in temperature, heating is performed for 5 minutes.

(3) The heat tensile test starts.

A tensile-stress to strain curve is obtained from the heat tensile test. In the present invention, assume that this curve is shown as the stress to stretch-magnification curve and the stretch magnification is expressed by a ratio N/M between a distance between chucks N after stretching and a distance between chucks M before stretching.

An upper limit of the temperature range is set to 300° C. Measurement is performed up to +10° C. from a temperature at which the amount of strain of a measured sample becomes maximum and subsequent measurement is not performed.

<Method for Measuring Elastic Coefficient of Intermediate Transfer Belt>

A sample having a width of 20 mm and a length of 100 mm is cut out from the intermediate transfer belt in a circumferential direction and a thickness thereof is measured, and then is placed in a tensile test machine (Tensilon UCT-500 manufactured by Orientec Co., Ltd.). The thickness is an average at five points of the sample. A measurement interval is set to 50 mm and a test speed is set to 5 mm/min. The heat tensile test is performed to record stretch and stress on a recorder. The stress at 1% is read and an elastic coefficient is calculated by the following expression. The measurement is performed 5 times. An average value becomes the elastic coefficient in the present invention.
Elastic Coefficient=(f/(20×t))×1000[MPa]
(in the expression, f indicates stress at 1% stretch [N] and t indicates a sample thickness [mm])
<Volume Resistivity Measuring Method>

An ultra-high resistance meter R8340A (manufactured by Advantest Corporation) is used as a resistance meter which is a measurement apparatus. A piece box for ultra-high resistance measurement TR42 (manufactured by Advantest Corporation) is used as a piece box. A main electrode has a diameter of 50 mm and a gird ring electrode has an inner diameter of 70 mm and an outer diameter of 75 mm.

A sample is produced as follows. First, an electrophotographic seamless belt is cut out in a circular shape having a diameter of 56 mm by a punching machine or a sharp cutter. An electrode madder of a Pt—Pd evaporation film is provided on the entirety of one surface of a cut-out circular piece, and a main electrode having a diameter of 25 mm and a guard electrode having an inner diameter of 38 mm and an outer diameter of 50 mm, which are made of a Pt—Pd evaporation film, are provided on the other surface thereof. The Pt—Pd evaporation film is obtained by evaporation operation for 2 minutes using Mild Sputter E1030 (manufactured by Hitachi Ltd.). A sample obtained after the evaporation operation is a measurement sample.

A measurement atmosphere is set to 23° C./55% RH. The measurement sample is left in advance in the same atmosphere for 12 hours or more. With respect to the measurement, a discharge time is set to 10 seconds, a charge time is set to 30 seconds, a major time is set to 30 seconds, and an applied voltage is set to 100V.

<Method of Measuring Film thickness of Electrophotographic Seamless Belt>

The film thickness of an electrophotographic seamless belt is measured as follows. A dial gauge in which a minimum value is 1 μm is used. All-around measurement is performed at four points in a circumferential direction at regular intervals with respect to a distance of 5:0 mm from each of both ends of the electrophotographic seamless belt and a center therebetween. In the case of the intermediate transfer belt, the measurement is performed in 15 points in total and an average value is obtained as the film thickness of the belt. The unevenness in film thickness of the electrophotographic seamless belt is expressed by ±% of a value obtained by the following expression
((maximum measurement data value in circumferential direction with respect to center−minimum measurement data therein)/2)/average film thickness of belt)×100

### EXAMPLE

Hereinafter, the present invention will be more specifically described with reference to examples. However, the present invention is not limited to only the examples.

### Example 1

[Preform Die]

A preform die having a shape capable of forming a preform (104) whose preform outer diameter “a” is 38.4 mm and preform longitudinal stretch portion length c is 96 mm in FIG. 12 is prepared.

[Blow Die]

A blow die (200) whose inner diameter b is 142 mm and longitudinal stretch portion d is 288 mm is prepared in FIG. 12.

That is, the radial stretch magnification (b/a) of the preform in this example is 3.7, the longitudinal stretch magnification d/c thereof is 3.0, and the entire stretch magnification obtained by multiplying the radial stretch-magnification by the longitudinal stretch magnification is 11.1.

[Preparation of Thermoplastic Resin Mixture]

Polyethylene Naphthalate Resin 81%

(TN-8065S: manufactured by Teijin Chemicals Ltd.)

Ionic conductive Resin 17%

(IRGASTAT P18: manufactured by Ciba Specialty Chemicals Co., Ltd.)

Potassium Perfluorobutanesulfonate 2%

(manufactured by Mitsubishi Materials Corporation)

The above-mentioned materials are melted and are mixed using a biaxial extrusion machine of φ30 mm (manufactured by The Japan Steel Works, Ltd., TEX30α, L/D=42) in the following condition to mix the respective material with one another are extruded by a strand having a diameter of about 2 mm, and are cut to obtain a pellet. This is used as a molding raw material 1.

(Mixing and Kneading Condition using Biaxial Extrusion Machine)

Screw: Double Thread Type, Two Kneeding Zones

Screw Rotation Speed: 200 rpm

Heating Temperature: Cylinder 2 250° C.

Cylinder 3 260° C.

Cylinders 4 to 11 210° C.

Die Head 270° C.

Discharge Rate: 15 kg/h

In the examples of this specification, the above-mentioned extrusion condition is used as a standard mixing and kneading condition and referred to as a “mixing and kneading condition 1”.

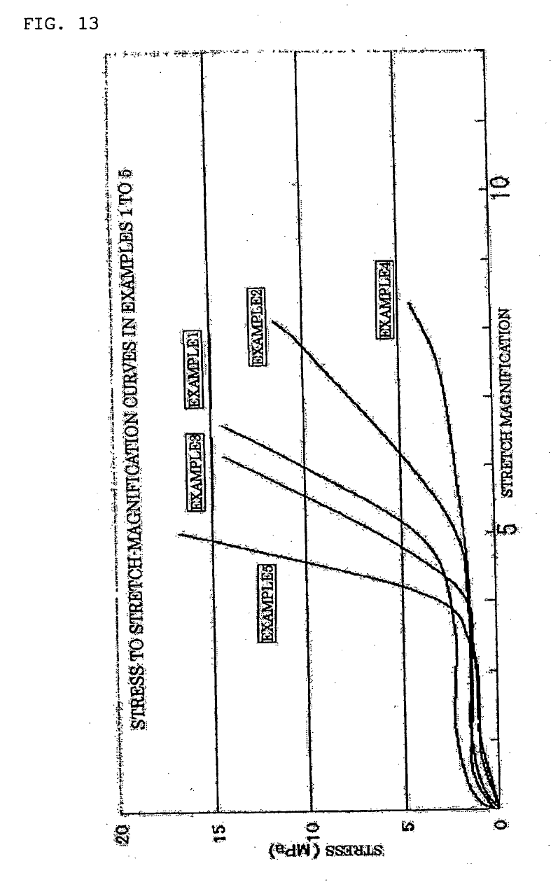

The molding raw material 1 is extruded at a extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 145° C. as shown in FIG. 13 is obtained. As is apparent from this stress to stretch-magnification curve, S/P becomes 2.0 to 15.0 in a radial stretch magnification range of 3.10 to 4.10 (when the magnification is larger than 4.10, a tensile-stress to strain curve exhibits breaking, so bursting occurs in the case where actual blowing is performed). In this example, the radial stretch magnification is 3.7. Therefore, of the stress P corresponding to 3.7×0.6 which is multiplication the radial stretch magnification and 0.6 is 2.40 MPa. In addition, of the stress S corresponding to 3.7×1.6 which is multiplication the radial stretch magnification and 1.6 is 9.80 MPa. Accordingly, S/P is 4.08.

Note that the stretch characteristic of thermoplastic resin mixture and the composition thereof are adjusted by the following material selection. Potassium perfluorobutanesulfonate added for resistance adjustment easily becomes a crystal nucleus and thus significantly affects an increase in stress on the stress to stretch-magnification curve. Therefore, a PEN resin (Teonex TN-8065S manufactured by Teijin Chemicals Ltd. (intrinsic viscosity ([η]=0.65)) having a low crystallization speed is selected as the thermoplastic resin.

[Manufacturing of Electrophotographic Seamless Belt]

A preform made of the molding raw material 1 is produced using the injection molding machine shown in FIG. 6. Note that a used injection molding machine is not limited to the machine shown in FIG. 6. The molding raw material 1 is melted at 275° C. After the completion of the melting, measurement/compression/injection using an injection screw are executed to inject the raw material to the perform molding die. After hording pressure, a cooling process in the die is performed and then, a molded part is taken out to obtain the preform.

The obtained preform is uniformly heated by a halogen heater at 145° C. which is equal to a temperature which is a condition in which S/P becomes 5, which is obtained from the heat tensile test performed on the sheet earlier, and then the process goes to a stretch blow molding step. Here, the heating temperature of the preform is a temperature at a center portion on the preform surface, which is measured 5 seconds before the blow molding starts (a moment at which the die is closed after the preform enters an inner portion of the die). The stretch blow molding is then performed to obtain a desirable stretch blow molded member having a bottle shape. After that, the stretch blow molded member having the bottle shape is cut in a desirable size with a belt width of 250 mm by an ultrasonic cutter to obtain a seamless intermediate transfer belt. This is referred to as an electrophotographic seamless belt (1). A final shape size of the obtained electrophotographic seamless belt (1) was 250 mm in axial length, 140 nm in diameter, and 140 μm in film thickness.

An electrical resistance of the electrophotographic seamless belt (1) when 100 V is applied thereto was 8.7×10⁹ Ωm. An elastic coefficient obtained from the heat tensile test is 18 MPa which is a high elastic coefficient. Film thicknesses of the electrophotographic seamless belt (1) at 15 points in the circumferential direction are measured using a dial gauge in which a minimum value is 1 μm. As a result, the belt film thickness is 140 μm±2.8%, that is, the unevenness in film thickness is small. This is preferable. A circumferential length difference between right and left opening portions (hereinafter referred to as a right-and-left difference) is 0.53 mm which is a preferable difference.

The electrophotographic seamless belt (1) is attached as the intermediate transfer belt to the full-color electrophotographic apparatus shown in FIG. 1 and a continuous endurance test in which 20000 A4-full-color images are successively printed out at a rate of 4 sheets per minute is performed in an atmosphere of 40° C./90%. The used full-color electrophotographic apparatus is LBP 2410 (trade name) manufactured by Canon Inc. A toner cartridge used for LBP 2410 is an EP-87 toner cartridge (4 colors of yellow, magenta, cyan, and black). A spring pressure of a tension roller during the continuous endurance test is 20 N in total of right-and-left, a slide distance is 2.5 mm, and a diameter of each of the tension roller and a drive roller is 28 mm. After the endurance test, a blue character image and line image, and a green character image and line image are printed on a paper of 80 g/m² using two colors of cyan and magenta and two colors of cyan and yellow, respectively. The respective images are visually observed. As a result, color shift does not occur and preferable running is obtained.

[Evaluation Method and Evaluation Standard]

Note that an evaluation method and an evaluation standard are as follows.

(Measurement of Unevenness in Film Thickness of Electrophotographic Seamless Belt)

An unevenness in film thickness of the seamless belt is measured as follows. Film thicknesses at 12 points in each of the belt circumferential direction and the axial direction are measured using a dial gauge in which a minimum value is 1 μm. The case where each of a difference between a maximum measurement value and an average film thickness value and a difference between a minimum measurement value and the average film thickness value is within 3% with respect to the average film thickness is expressed by ⊚, the case where it is within 5% is expressed by ◯, the case where it is in a range of over 5% to 8% is expressed by Δ, and the case where it is larger than 8% is expressed by X. Then, the film thickness precision is evaluated. Note that ⊚ in the evaluation standard indicates the most preferable result. A result deteriorates as the the difference value approaches X. Results are shown in Table 1.

Measurement points are the center of the belt in the circumferential direction and a start point for circumferential direction measurement in the axial direction.

(Method of Measuring Circumferential Length Difference (Right-and-Left Difference) of Electrophotographic Seamless Belt)

A circumferential length in a point located at a distance of 5 mm from both ends of a seamless belt obtained by cutting both upper and lower ends of the seamless belt obtained after the stretch blow molding to the center thereof is measured to calculate a circumferential length difference. The case where a right-and-left circumferential length difference is within 0.5 mm is expressed by ⊚, the case where it is in a range of over 0.5 mm to under 1.0 mm is expressed by ◯, the case where it is in a range of 1.0 mm to under 2.0 mm is expressed by Δ, and the case where it is equal to or larger than 2.0 mm is expressed by X. Evaluation results are shown in Table 1.

(Durable Image Characteristic)

The electrophotographic seamless belt is attached to the full-color electrophotographic apparatus shown in FIGS. 1, 2 or 3 and the continuous endurance test in which 20000 A4-size images are printed out is performed in 40° C./90%. After that, a blue character image and line image, and a green character image and line image are printed on a paper of 80 g/m² using two colors of cyan and magenta and two colors of cyan and yellow, respectively. The respective images obtained after the endurance test are visually determined for color shift evaluation (◯: good, Δ: substantially good, X: bad). Evaluation results are shown in Table 1.

### Example 2

[Preform Die and Blow Die]

A preform die having a shape capable of forming a preform (104) whose preform outer diameter “a” is 33.8 mm and preform longitudinal stretch portion length c is 92 mm in FIG. 12 is prepared. A blow die identical to that used in Example 1 is prepared.

That is, the radial stretch magnification (b/a) of the preform in this example becomes 4.2, the longitudinal stretch magnification d/c thereof is 3.0, and the entire stretch magnification obtained by multiplication of the radial stretch magnification and the longitudinal stretch magnification is 12.6.

[Preparation of Thermoplastic Resin Mixture]

Polyethylene Naphthalate Resin 78%

(TN-8065S: manufactured by Teijin Chemicals Ltd.)

Polyetherester Resin 19%

(4047X08: manufactured by Du Pont-Toray Co., Ltd.) potassium perfluorobutanesulfonate 3%

(manufactured by Mitsubishi Materials Corporation)

The above-mentioned materials are melted and are mixed using the biaxial extrusion machine of φ30 mm (manufactured by The Japan Steel Works, Ltd., TEX30α, L/D=42) in the mixing and kneading condition 1 to mix the respective material with one another, are extruded by a strand having a diameter of about 2 mm, and are cut to obtain a pellet. This is used as a molding raw material 2.

The molding raw material 2 is extruded at a heating temperature of 280° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 145° C. as shown in FIG. 13 is obtained. As is apparent from this stress to stretch-magnification curve, S/P becomes 2.0 to 15.0 in a radial stretch magnification range of 3.39 to 5.10 (when the magnification is larger than 5.10, a tensile-stress to strain curve exhibits breaking, so bursting occurs in the case where actual blowing is performed). In this example, the radial stretch magnification is 4.2. Therefore, the stress P obtained by multiplication of the radial stretch magnification and 0.6 is 1.50 MPa. In addition, the stress S obtained by multiplication of the radial stretch magnification and 1.6 is 7.00 MPa. Thus, S/P is 4.67.

[Manufacturing of Electrophotographic Seamless Belt and Evaluation Thereof]

The molding raw material 2 is used and the perform heating temperature is set to 145° C. Then, the stretch blow molding is performed by the same method as that in Example 1 to obtain an electrophotographic seamless belt (2) whose final shape size is 250 mm in axial length, 140 mm in diameter, and 150 μm in film thickness. An endurance test and evaluation are performed on the obtained electrophotographic seamless belt (2) as in Example 1. A stress to stretch-magnification curve of the thermoplastic resin composition used to mold the electrophotographic seamless belt (2) at 145° C. is shown in FIG. 13 and an evaluation result thereof is shown in Table 1.

### Example 3

[Preform Die]

A preform die having a shape capable of forming a preform (104) whose preform outer diameter “a” is 63.5 mm and preform longitudinal stretch portion length c is 120 mm in FIG. 12 is prepared.

[Blow Die]

A blow die (200) whose inner diameter b is 216 mm and longitudinal stretch portion d is 288 mm is prepared in FIG. 12.

That is, the radial stretch magnification (b/a) of the preform in this example is 3.4, the longitudinal stretch magnification d/c thereof is 2.4, and the entire stretch magnification obtained by multiplication of the radial stretch magnification and the longitudinal stretch magnification is 8.2.

[Manufacturing of Electrophotographic Seamless Belt and Evaluation Thereof]

The molding raw material 2 used in Example 2 is extruded at a heating temperature of 280° C. by a φ50 uniaxial T-dies extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 140° C. as shown in FIG. 13 is obtained. As is apparent from this stress to stretch-magnification curve, S/P becomes 2.0 to 15.0 in a radial stretch magnification range of 2.7 to 3.9 (when the magnification is larger than 3.9, a tensile-stress to strain curve exhibits breaking, so bursting occurs in the case where actual blowing is performed). In this example, the radial stretch magnification is 3.4. Therefore, the stress P obtained by multiplication of the radial stretch magnification and 0.6 is 1.50 MPa. In addition, the stress S obtained by multiplication of the radial stretch magnification and 1.6 is 9.20 MPa. Thus, S/P is 6.13.

The molding raw material 2 is used and the preform heating temperature is adjusted to 140° C. Then, the stretch blow molding is performed by the same method as that in Example 1 to obtain an electrophotographic seamless belt (3) whose final shape size is 250 mm in axial length, 214 mm in diameter, and 110 μm in film thickness. Next, the obtained electrophotographic seamless belt (3) is incorporated as the transfer material transport belt 16 in the full-color electrophotographic apparatus (LBP 5500 manufactured by Canon Inc.) shown in FIG. 2 and an endurance test and evaluation are performed as in Example 1. A toner cartridge used here is an EP-85 toner cartridge (4 colors of yellow, magenta, cyan, and black). A stress to stretch-magnification curve of the thermoplastic resin composition used to mold the electrophotographic seamless belt (3) at 140° C. is shown in FIG. 13 and an evaluation result thereof is shown in Table 1.

### Example 4

[Preform Die]

A preform die having a shape capable of forming a preform (104) whose preform outer diameter “a” is 61.0 mm and preform longitudinal stretch portion length c is 146.4 mm in FIG. 12 is prepared.

[Blow Die]

A blow die (200) whose inner diameter b is 311 mm and longitudinal stretch portion d is 410 mm is prepared in FIG. 12.

That is, the radial stretch magnification (b/a) of the preform in this example is 5.1, the longitudinal stretch magnification d/c thereof is 2.8, and the entire stretch magnification obtained by multiplication of the radial stretch magnification and the longitudinal stretch magnification is 14.28.

[Preparation of Thermoplastic Resin Mixture]

Polyethylene Terephthalate Resin 77.5%

(Mitsui PET J125: manufactured by Mitsui Chemicals, Inc.)

Polyetherester Resin 20%

(4047X08: manufactured by Du Pont-Toray Co., Ltd.)

Potassium Perfluorobutanesulfonate 2.5%

(manufactured by Mitsubishi Materials Corporation)

The above-mentioned materials are melted and are mixed using the biaxial extrusion machine of φ30 mm (manufactured by The Japan Steel Works, Ltd., TEX30α, L/D=42) in the mixing and kneading condition 1 to mix the respective material with one another, are extruded by a strand having a diameter of about 2 mm, and are cut to obtain a pellet. This is used as a molding raw material 3.

The molding raw material 3 is extruded at a heating temperature of 280° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 100° C. as shown in FIG. 13 is obtained. As is apparent from this stress to stretch-magnification curve, S/P becomes 2.0 to 15.0 in a radial stretch magnification range of 4.75 to 5.21 (when the magnification is larger than 5.21, a tensile-stress to strain curve exhibits breaking, so bursting occurs in the case where actual blowing is performed). In this example, the radial stretch magnification is 5.1. Therefore, the stress P obtained by multiplication of the radial stretch magnification and 0.6 is 1.50 MPa. In addition, the stress S obtained by multiplication of the radial stretch magnification and 1.6 is 4.09 MPa. Thus, S/P is 2.73.

[Manufacturing of Electrophotographic Seamless Belt and Evaluation Thereof]

The molding raw material 3 is used and the perform heating temperature is adjusted to 100° C. Then, the stretch blow molding is performed by the same method as that in Example 1 to obtain an electrophotographic seamless belt (4) whose final shape size is 350 mm in axial length, 309 mm in diameter, and 80 μm in film thickness. The obtained electrophotographic seamless belt (4) is incorporated as the intermediate transfer belt in the full-color electrophotographic apparatus shown in FIG. 3 and an endurance test and evaluation are performed as in Example 1. The used full-color electrophotographic apparatus is HP Color LaserJet 9500hdn (trade name) manufactured by Hewlett-Packard Development Company. A toner cartridge used for HP Color LaserJet 9500hdn has 4 colors of C8550A (black), C8551A (cyan), C8552A (yellow), and C8553A (magenta). A stress to stretch-magnification curve of the thermoplastic resin composition used to mold the electrophotographic seamless belt (4) at 100° C. is shown in FIG. 13 and an evaluation result thereof is shown in Table 1.

### Example 5

[Preform Die and Blow Die]

A preform die having a shape capable of forming a preform (104) whose preform outer diameter “a” is 100.3 mm and preform longitudinal stretch portion length c is 211.3 mm in FIG. 12 is prepared. A blow die identical to that used in Example 4 is prepared.

That is, the radial stretch magnification (b/a) of the preform in this example is 3.1, the longitudinal stretch magnification d/c thereof is 1.94, and the entire stretch magnification obtained by multiplication of the radial stretch magnification and the longitudinal stretch magnification is 6.01.

[Preparation of Thermoplastic Resin Mixture]

Polyamide Resin 80%

(MX Nylon 36121: manufactured by Mitsubishi Gas Chemical Company, Inc.)

Polyetherester Resin 15%

(4047X08: manufactured by Du Pont-Toray Co., Ltd.)

The above-mentioned materials are melted and are mixed using the biaxial extrusion machine of φ30 mm (manufactured by The Japan Steel Works, Ltd., TEX30α, L/D=42) in the following condition to mix the respective material with one another, are extruded by a strand having a diameter of about 2 mm, and are cut to obtain a pellet. This is used as a molding raw material 4.

(Biaxial Extrusion Machine Condition)

Screw: Double Thread Type, No Kneeding Zone

Screw Rotation Speed: 200 rpm

Heating Temperature: Cylinder 2 240° C.

Cylinder 3 250° C.

Cylinders 4 to 11 260° C.

Die Head 260° C.

Discharge Rate: 25 kg/h

Note that the above-mentioned extrusion condition is used as a “mixing and kneading condition 2” (weak mixing and kneading).

The molding raw material 4 is extruded at a heating temperature of 270° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. The obtained stress to stretch-magnification curves are examined. As a result, a stress to stretch-magnification curve at 110° C. as shown in FIG. 13 is obtained. As is apparent from this stress to stretch-magnification curve, S/P becomes 2.0 to 15.0 in a radial stretch magnification range of 2.36 to 3.10. In this example, the radial stretch magnification is 3.10. Therefore, the stress P obtained by multiplication of the radial stretch magnification and 1.6 is 1.00 MPa. In addition, the stress S obtained by multiplication of the radial stretch magnification and 1.6 is 15.00 MPa, and S/P is 15.00. In this example, a weak mixing and kneading is adopted for the mixing and kneading condition of the molding raw material 4, thereby adjusting increase in the stress in the obtained stress to stretch-magnification curves to be larger.

[Manufacturing of Electrophotographic Seamless Belt and Evaluation Thereof]

The molding raw material 4 is used and the perform heating temperature is adjusted to 110° C. Then, the stretch blow molding is performed by the same method as that in Example 1 to obtain an electrophotographic seamless belt (5) whose final shape size is 350 mm in axial length, 309 mm in diameter, and 105 μm in film thickness. The obtained electrophotographic seamless belt (4) is incorporated as the intermediate transfer belt in the full-color electrophotographic apparatus shown in FIG. 3 and an endurance test and evaluation are performed as in Example 1. The used full-color electrophotographic apparatus is HP Color LaserJet 9500hdn (trade name) manufactured by Hewlett-Packard Development Company. A toner cartridge used for HP Color LaserJet 9500hdn has 4 colors of C8550A (black), C8551A (cyan), C8552A (yellow), and C8553A (magenta). A stress to stretch-magnification curve of the thermoplastic resin composition used to mold the electrophotographic seamless belt (5) at 110° C. is shown in FIG. 13 and an evaluation result thereof is shown in Table 1.

### Comparative Example 1

[Preform Die and Blow Die]

A preform die having a shape capable of forming a preform (104) whose preform outer diameter “a” is 47.3 mm and preform longitudinal stretch portion length c is 96.0 mm in FIG. 12 is prepared. A blow die identical to that used in Example 1 is prepared.

That is, the radial stretch magnification (b/a) of the preform in this comparative example is 3.0, the longitudinal stretch magnification d/c thereof is 3.0, and the entire stretch magnification obtained by multiplication of the radial stretch magnification and the longitudinal stretch magnification is 9.0.

[Preparation of Thermoplastic Resin Mixture]

Polyethylene Terephthalate Resin 77.5%

(Mitsui PET J135: manufactured by Mitsui Chemicals, Inc.)

Polyetherester Resin 20%

(4.047X08: manufactured by Du Pont-Toray Co., Ltd.)

Potassium Perfluorobutanesulfonate 2.5% (manufactured by Mitsubishi Materials Corporation)

The above-mentioned materials are melted and are mixed using the biaxial extrusion machine of φ30 mm (manufactured by The Japan Steel Works, Ltd., TEX30α, L/D=42) in the mixing and kneading condition 1 to mix the respective material with one another, are extruded by a strand having a diameter of about 2 mm, and are cut to obtain a pellet. This is used as a molding raw material 5.

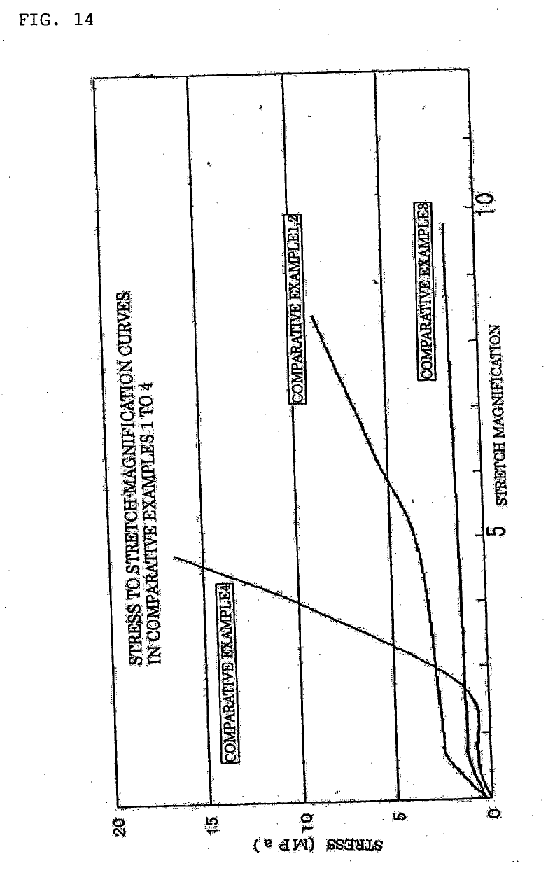

The molding raw material 5 is extruded at a heating temperature of 280° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 110° C. as shown in FIG. 14 is obtained. As is apparent from this stress to stretch-magnification curve, when the radial stretch magnification is equal to or smaller than 3.66, S/P becomes 2.0 or less. Therefore, the stretch magnification (3.0) in this comparative example is outside the range in which S/P is 2 to 15. In this comparative example, the stress P obtained by multiplication of the radial stretch magnification and 0.6 is 2.42 MPa. In addition, the stress S obtained by multiplication of the radial stretch magnification and 1.6 is 3.63 MPa. Thus, S/P is 1.5.

[Manufacturing of Electrophotographic Seamless Belt and Evaluation Thereof]

The molding raw material 5 is used and the perform heating temperature is adjusted to 110° C. Then, the stretch blow molding is performed by the same method as that in Example 1 to obtain an electrophotographic seamless belt (6) whose final shape size is 250 mm in axial length, 139 mm in diameter, and 32 μm in film thickness. An endurance test and evaluation are performed on the obtained electrophotographic seamless belt (6) as in Example 1. A stress to stretch-magnification curve of the thermoplastic resin composition used to mold the electrophotographic seamless belt (6) at 110° C. is shown in FIG. 14 and an evaluation result thereof is shown in Table 1.

### Comparative Example 2

[Preform Die and Blow Die]

A preform die having a shape capable of forming a preform (104) whose preform outer diameter “a” is 47.3 mm and preform longitudinal stretch portion length c is 172.5 mm in FIG. 12 is prepared. A blow die identical to that used in Example 1 is prepared.

That is, the radial stretch magnification (b/a) of the preform in this comparative example is 3.0, the longitudinal stretch magnification d/c thereof is 1.7, and the entire stretch magnification obtained by multiplication of the radial stretch magnification and the longitudinal stretch magnification is 5.10.

[Manufacturing of Electrophotographic Seamless Belt and Evaluation Thereof]

The molding raw material 5 used in Comparative Example 1 is extruded at a heating temperature of 280° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 110° C. as shown in FIG. 14 is obtained. As is apparent from this stress to stretch-magnification curve, when the radial stretch magnification is equal to or smaller than 3.66, S/P becomes 2.0 or less. Therefore, the stretch magnification (3.0) in this comparative example is outside the range in which S/P is 2 to 15. In this comparative example, the stress P obtained by multiplication of the radial stretch magnification and 0.6 is 2.42 MPa. In addition, the stress S obtained by multiplication of the radial stretch magnification and 1.6 is 3.63 MPa. Thus, S/P is 1.5.

The molding raw material 5 is used and the stretch blow molding is performed by the same method as that in Comparative Example 1 to obtain an electrophotographic seamless belt (7) whose final shape size is 250 mm in axial length, 140 mm in diameter, and 38 μm in film thickness. An endurance test and evaluation are performed on the obtained electrophotographic seamless belt (7) as in Example 1. A stress to stretch-magnification curve of the thermoplastic resin mixture used to mold the electrophotographic seamless belt (7) at 150° C. is shown in FIG. 14 and an evaluation result thereof is shown in Table 1.

### Comparative Example 3

[Preform Die and Blow Die]

A preform die having a shape capable of forming a preform (104) whose preform outer diameter “a” is 23.7 mm and preform longitudinal stretch portion length c is 127.4 mm in FIG. 12 is prepared. A blow die identical to that used in Example 1 is prepared.

That is, the radial stretch magnification (b/a) of the preform in this comparative example is 6.0, the longitudinal stretch magnification d/c thereof is 2.3, and the entire stretch magnification obtained by multiplication of the radial stretch magnification and the longitudinal stretch magnification is 13.80.

[Preparation of Thermoplastic Resin Mixture]

Polyethylene Terephthalate Resin 77.5%

(Mitsui PET J125: manufactured by Mitsui Chemicals, Inc.)

Polyetherester Resin 20%

(4047X08s: manufactured by Du Pont-Toray Co., Ltd.) Potassium Perfluorobutanesulfonate 2.5%

(manufactured by Mitsubishi Materials Corporation)

The above-mentioned materials are melted and are mixed using the biaxial extrusion machine of φ30 mm (manufactured by The Japan Steel Works, Ltd., TEX30α, L/D=42) in the following condition to mix the respective material with one another, are extruded by a strand having a diameter of about 2 mm, and are cut to obtain a pellet. This is used as a molding raw material 6.

(Biaxial Extrusion Machine Condition)

Screw: Double Thread Type, Four Kneeding Zones

Screw Rotation Speed: 300 rpm.

Heating Temperature: Cylinder 2 250° C.

Cylinder 3 260° C.

Cylinders 4 to 11 270° C.

Die Head 270° C.

Discharge Rate: 7 kg/h

Note that the above-mentioned extrusion condition is used as a “mixing and kneading condition 3” (strong mixing and kneading).

The molding raw material 6 is extruded at a heating temperature of 280° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 110° C. as shown in FIG. 14 is obtained. As is apparent from this stress to stretch-magnification curve, even when the radial stretch magnification is equal to or larger than 6, S/P is equal to or smaller than 2. This may be because, although the same thermoplastic resin mixture as that in Example 4 is used in this comparative example, the heating temperature is higher than that in Example 4 by 10° C. and the mixing and kneading condition is the strong mixing and kneading, so a reduction in molecular weight of the thermoplastic resin mixture occurs. The radial stretch magnification in this comparative example is 6.0. Therefore, the stress P obtained by multiplication of the radial stretch magnification and 0.6 is 1.36 MPa. In addition, the stress S obtained by multiplication of the radial stretch magnification and 1.6 is 1.88 MPa. Thus, S/P is 1.4.

[Manufacturing of Electrophotographic Seamless Belt and Evaluation Thereof]

The molding raw material 6 is used and the perform heating temperature is adjusted to 110° C. Then, the stretch blow molding is performed by the same method as that in Example 1 to obtain an electrophotographic seamless belt (8) whose final shape size is 250 mm in axial length, 140 mm in diameter, and 260 μm in film thickness. An endurance test and evaluation are performed on the obtained electrophotographic seamless belt (8) as in Example 4. A stress to stretch-magnification curve of the thermoplastic resin composition used to mold the electrophotographic seamless belt (8) at 110° C. is shown in FIG. 14 and an evaluation result thereof is shown in Table 1.

### Comparative Example 4

A preform die and a blow die which are identical to those used in Example 5 are prepared. That is, in this comparative example, the radial stretch magnification (b/a) of the preform is 3.1, the longitudinal stretch magnification d/c thereof is 1.94 and the entire stretch magnification obtained by multiplication of the radial stretch magnification and the longitudinal stretch magnification is 6.01.

The molding raw material 4 used in Example 5 is extruded at a heating temperature of 280° C. by a φ50 uniaxial T-die extrusion apparatus to mold a sheet having a thickness of 150 μm. The obtained sheet is subjected to the heat tensile test based on JIS K7161 at intervals of 5° C. in the range of 80° C. to 300° C. Obtained stress to stretch-magnification curves are examined. As a result, a stress to stretch-magnification curve at 95° C. as shown in FIG. 14 is obtained. As is apparent from this stress to stretch-magnification curve, when the radial stretch magnification is in a range of 1.58 to 2.63, S/P becomes 2 to 15. In this comparative example, the same die as that in Example 5 is used. At this time, the stress P obtained by multiplication of the radial stretch magnification and 0.6 is 0.78 MPa. The stress S obtained by multiplication of the radial stretch magnification and 1.6 cannot be measured because of breaking. Therefore, S/P cannot be calculated. However, the stress is 16.5 MPa at the time of breaking (stretch magnification is 4.70) and S/P at the time of breaking is 21. Thus, S/P in this comparative example is considered to be a value larger than 15.

The molding raw material 4 is used and the perform heating temperature is changed to 95° C. Then, the stretch blow molding is performed by the same method as that in Example 5. However, molding cannot be made because of bursting. Therefore, image evaluation cannot be performed. An evaluation result of Comparative Example 4 is shown in Table 1. A stress to stretch-magnification curve of the thermoplastic resin composition used in this comparative example at 95° C. is shown in FIG. 14 and an evaluation result thereof is shown in Table 1.

TABLE 1

| | | | Radial × | Tensile | | | Axial | right-and-left | |
|---|---|---|---|---|---|---|---|---|---|
| | | | longitudinal | elastic | Volume | Circumferential | unevenness | circumferential | Endurance |
| | | Radial stretch | stretch | coefficient | resistivity | unevenness in | in film | length | image |
| | S/P | magnification | magnification | (Mpa) | (Ω · cm) | film thickness | thickness | difference | evaluation |
| Example 1 | 4.08 | 3.7 | 11.10 | 18.0 | 8.70E+09 | ⊚ | ⊚ | ⊚ | ◯ |
| Example 2 | 4.67 | 4.2 | 12.60 | 17.4 | 3.00E+10 | ⊚ | ⊚ | ◯ | ◯ |
| Example 3 | 6.13 | 3.4 | 8.16 | 11.0 | 1.50E+10 | ⊚ | ⊚ | ◯ | ◯ |
| Example 4 | 2.73 | 5.1 | 14.28 | 19.2 | 5.80E+10 | ◯ | ⊚ | ◯ | ◯ |
| Example 5 | 15.00 | 3.1 | 6.01 | 19.0 | 4.30E+11 | ◯ | ◯ | Δ | ◯ |
| Comparative | 1.5 | 3.0 | 9.00 | 18.0 | 8.00E+08 | X | X | Δ | X |
| Example 1 | | | | | | | | | |
| Comparative | 1.5 | 3.0 | 5.10 | 8.8 | 5.15E+08 | X | X | Δ | X |
| Example 2 | | | | | | | | | |
| Comparative | 1.4 | 6.0 | 13.80 | 5.3 | 5.30E+13 | X | X | X | X |
| Example 3 | | | | | | | | | |
| Comparative | larger than 15 | 3.1 | 6.01 | — | — | — | — | — | — |
| Example 4 | | | | | | | | | |

### INDUSTRIAL APPLICABILITY

According to the present invention, it is possible to provide a method capable of stably manufacturing an electrophotographic seamless belt at low cost which has an even film thickness, is excellent in size precision and durability, and ensures excellent image characteristics even when it is repeatedly used. In addition, when the electrophotographic seamless belt obtained by the manufacturing method is used for an electrophotographic apparatus, it is possible to provide an apparatus capable of forming an excellent image in which a variation due to environments is small even when the electrophotographic seamless belt is repeatedly used.

This application claims priority from Japanese Patent Application No. 2004-261464 filed on Sep. 8, 2004, which is hereby incorporated by reference herein.

1. A method of manufacturing an electrophotographic seamless belt, comprising:
(i) a step of setting a substantially cylindrical preform, which is made of a thermoplastic resin mixture containing a thermoplastic resin and has an outer diameter “a”, in a seamless belt molding die including a cylindrical cavity having an inner diameter “b”, and performing stretch blow molding at a predetermined stretch temperature T1 to obtain a stretch-blow-molded part; and
(ii) a step of cutting the stretch-blow-molded part obtained by the step (i) to obtain a seamless belt;
wherein the thermoplastic resin mixture has a temperature T2 at which a parameter S/P calculated from a tensile-stress to strain curve obtained by performing a heat tensile test based on JIS K7161 on a sheet test piece made of the thermoplastic resin mixture becomes 2.0 to 15.0; and
the temperature T2 is set as the predetermined stretch temperature T1 in the step (i).
(where P indicates stress when a stretch magnification of a test piece corresponds to 0.6×(b/a) in a case where a stretch magnification is 1 at an amount of strain of 0 on the tensile-stress to strain curve, S indicates stress when the stretch magnification of the test piece corresponds to 1.6×(b/a), and a value of (b/a)≧1.7)

2. A method of manufacturing an electrophotographic seamless belt according to claim 1, wherein
the value of (b/a) is in a range of 3.1 to 5.0.

3. A method of manufacturing an electrophotographic seamless belt according to claim 2, wherein
the value of (b/a) is in a range of 3.8 to 4.5.

4. An electrophotographic apparatus, comprising:
an electrophotographic photosensitive member including a support member;
charging means for charging the electrophotographic photosensitive member;
latent image forming means for forming an electrostatic latent image on the charged electrophotographic photosensitive member;
developing means for visualizing the electrostatic latent image using a developer;
an intermediate transfer belt; and
transfer means including primary transfer means for transferring the visualized image to the intermediate transfer belt and secondary transfer means for transferring the image which is transferred to the intermediate transfer belt to a transfer material;
wherein the intermediate transfer belt is the electrophotographic seamless belt manufactured by the manufacturing method according to any one of claims 1 to 3.

5. An electrophotographic apparatus according to claim 4, wherein the transfer means further comprises cleaning means for charging a developer remaining on the intermediate transfer belt to a polarity opposite to that in primary transfer and returning the developer remaining on the intermediate transfer belt to the electrophotographic photosensitive member simultaneously with the primary transfer.

6. An electrophotographic apparatus, comprising:
an electrophotographic photosensitive member including a support member;
charging means for charging the electrophotographic photosensitive member;
latent image forming means for forming an electrostatic latent image on the charged electrophotographic photosensitive member;
developing means for visualizing the electrostatic latent image using a developer; and
transfer means including a transfer material transport belt for transporting a transfer material while the visualized image is transferred to the transfer material for each color;
wherein the transfer material transport belt is the electrophotographic seamless belt manufactured by the manufacturing method according to any one of claims 1 to 3.
